(19) United States
(12) Patent Application Publication
(10) Pub. No.: US 2024/0329805 A1
(43) Pub. Date: Oct. 3, 2024

(54) METHOD OF INPUTTING CHARACTER AND ASSOCIATED COMPUTER PROGRAM PRODUCT, CLOUD SYSTEM, AND ELECTRONIC DEVICE, AND METHOD OF INDEXING CHARACTER

(71) Applicants: POR-SEN JAW, TAIPEI CITY (TW); YIN-PING CHAO, TAIPEI CITY (TW)

(72) Inventors: POR-SEN JAW, TAIPEI CITY (TW); YIN-PING CHAO, TAIPEI CITY (TW)

(21) Appl. No.: 18/620,123

(22) Filed: Mar. 28, 2024

(30) Foreign Application Priority Data
Mar. 30, 2023 (TW) 112112222

(51) Int. Cl. G06F 3/0482; G06F 3/0484; G06F 3/0487

(52) U.S. Cl. CPC G06F 3/0482; G06F 3/0484; G06F 3/0487

(57) ABSTRACT

The subject invention is a method of inputting a character and associated computer program product, cloud system, and electronic device, and a method of indexing a character. The method of inputting a character includes: receiving a command which indicates an element; receiving a command to select one of a plurality of features which classify a group of roots associated with the element; displaying a form list in response to the command; and receiving a command to select a form in the form list to complete an input of a character.

### BACKGROUND OF THE INVENTION

### Field of the Invention

The subject invention relates to a method of inputting a character and associated computer program product, cloud system, and electronic device, and a method of indexing a character. Specifically, the subject invention relates to inputting of a character and/or indexing of a character based on an element, a root, and a form. Through a process of inputting a command, a code of a character can be found. Each character has a unique five-digit code including letters and numerals, or a six-digit code including numerals, which is associated with the character.

### Description of the Prior Art

There are many coding systems for character input methods. For example, the input of Chinese characters is basically based on two attributes: Chinese pronunciation and glyphs. In pronunciation-based input methods such as a “Microsoft phonetic input method” or “pinyin input method, Chinese characters can be input by phonetic symbols or Roman pinyin. In glyph input methods such as “radical method”, “Cangjie input method”, and “Wubi font input method”, all Chinese characters can be decomposed and can also be input using a standard keyboard. However, such input methods are not helpful for people who do not know Chinese or beginners to read, and cannot be used as a teaching tool.

In recent years, millions of European and American young people and overseas Chinese haven begun to study Chinese for the purposes of studying, cultural research, business visits, and traveling in China. However, Chinese and Western languages have different ways of thinking and different structural rules, making it difficult for those foreigners to learn. Therefore, it is mistakenly believed that “Chinese is the most difficult language to learn in the world.”

### SUMMARY OF THE INVENTION

The subject invention provides a method of inputting a character, including: receiving, by a user interface, a first command, the first command indicating an element; displaying a first menu, the first menu including a plurality of first features that classify a first group of roots associated with the element; receiving, by the user interface, a second command to select one of the plurality of first features; displaying a second menu, the second menu including a plurality of second features that classify a second group of roots in the first group of roots, where the plurality of first features are different from the plurality of second features; receiving, by the user interface, a third command to select one of the plurality of second features; displaying a form list in response to at least the first command, the second command, and the third command; and receiving, by the user interface, a fourth command to select a form in the form list to complete an input of a character.

The subject invention provides an electronic device for inputting a character, including a display unit, a user interface, and a processor, configured to perform the following steps: receiving, by the user interface, a first command, the first command indicating an element; displaying, by the display unit and the processor, a first menu, the first menu including a plurality of first features that classify a first group of roots associated with the element; receiving, by the user interface, a second command to select one of the plurality of first features; generating, by the display unit and the processor, a second menu, the second menu including a plurality of second features that classify a second group of roots in the first group of roots, where the plurality of first features are different from the plurality of second features; receiving, by the user interface, a third command to select one of the plurality of second features; displaying, by the display unit and the processor, a form list in response to at least the first command, the second command, and the third command; and receiving, by the user interface, a fourth command to select a form in the form list to complete an input of a character.

The subject invention provides a computer program product for inputting a character, loaded by a computer to perform the following steps: receiving a first command, the first command indicating an element; displaying a first menu, the first menu including a plurality of first features that classify a first group of roots associated with the element; receiving a second command to select one of the plurality of first features; displaying &-second menu, the second menu including a plurality of second features that classify a second group of roots in the first group of roots, where the plurality of first features are different from the plurality of second features; receiving a third command to select one of the plurality of second features; displaying a form list in response to at least the first command, the second command, and the third command; and receiving a fourth command to select a form in the form list to complete an input of a character.

The subject invention provides a cloud system for inputting a character, including an input module and a processing module, configured to perform the following steps: receiving, by the input module, a first command, the first command indicating an element; generating, by the processing module, a first menu, the first menu including a plurality of first features that classify a first group of roots associated with the element; receiving, by the input module, a second command to select one of the plurality of first features; generating, by the processing module, a second menu, the second menu including a plurality of second features that classify a second group of roots in the first group of roots, where the plurality of first features are different from the plurality of second features; receiving, by the input module, a third command to select one of the plurality of second features; generating, by the processing module, a form list in response to at least the first command, the second command, and the third command; and receiving, by the input module, a fourth command to select a form in the form list to complete an input of a character.

The subject invention provides a method of indexing a character, including: receiving, by a user interface, a character; determining, by a processor, a lower or right element of the character to generate a first code; determining, by the processor, one of a plurality of first features corresponding to the character; determining, by the processor, a plurality of second features that classify a second group of roots in a first group of roots, where the plurality of first features are different from the plurality of second features; determining, by the processor, one of the plurality of second features corresponding to the character; determining, by the processor, a root in the second group of roots according to the corresponding first feature and the corresponding second feature, the root having a second code; and comparing each of a form list of the root with the character to generate a third code.

The subject invention provides a method of inputting a character, including: inputting, by a user interface or an input/output module, a first command to select one of a plurality of elements; inputting, by the user interface or the input/output module, an N^{th} command, where N is a positive integer greater than or equal to 2, to select one of an (N−1)^{th} (N minus 1) group of root features in an (N−1)^{th} menu, which corresponds to an (N−1)^{th} group of roots, and displaying, by the user interface or the input/output module, an N^{th} menu including the (N−1)^{th} group of roots; inputting, by the user interface or the input/output module, an (N+1)^{th} (N plus 1) command to select one of the (N−1)^{th} group of roots in an N^{th} menu, and displaying, by the user interface or the input/output module, an (N+1)^{th} menu including a form list corresponding to the selected root; and/or inputting, by the user interface or the input/output module, an (N+2)^{th} command to select one of the form list of the (N+1)^{th} menu to complete an input of a character.

One of Emphases of the subject invention is to introduce Chinese culture. Characters are a main carrier of cultural existence, so to make overseas Chinese students understand Chinese culture, literacy is the first priority. Through a new method of inputting a character and/or a method for indexing a character, a low threshold for the overseas Chinese students to learn Chinese can be achieved.

### BRIEF DESCRIPTION OF THE DRAWINGS

The aspects of this application will become more comprehensible from the following detailed description made with reference to the accompanying drawings. It should be noted that, various features may not be drawn to scale, and the sizes of the various features may be increased or reduced arbitrarily for the purpose of clear description.

FIG. 1 is a schematic diagram of an electronic device according to some embodiments of the subject invention.

FIG. 2 is a schematic diagram of a cloud system according to some embodiments of the subject invention.

FIG. 3 is an element table according to some embodiments of the subject invention. FIG. 3 contains foreign characters to illustrate the instant invention; and these foreign characters form no part of the instant invention.

FIG. 4 is a root table according to some embodiments of the subject invention. FIG. 4 contains foreign characters to illustrate the instant invention; and these foreign characters form no part of the instant invention.

FIG. 5 is a form indexing according to some embodiments of the subject invention. FIG. 5 contains foreign characters to illustrate the instant invention; and these foreign characters form no part of the instant invention.

FIG. 6 is a root table according to some embodiments of the subject invention. FIG. 6 contains foreign characters to illustrate the instant invention; and these foreign characters form no part of the instant invention.

FIG. 7 is a form indexing according to some embodiments of the subject invention. FIG. 7 contains foreign characters to illustrate the instant invention; and these foreign characters form no part of the instant invention.

FIG. 8 is a method of inputting a character according to some embodiments of the subject invention.

FIGS. 9A, 9B, 9C, 9D, 9E, and 9F are a user interface according to some embodiments of the subject invention. FIGS. 9C, 9D, 9E, and 9F contain foreign characters to illustrate the instant invention; and these foreign characters form no part of the instant invention.

FIG. 10 is a method of inputting a character according to some embodiments of the subject invention.

FIGS. 11A, 11B, and 11C are a user interface according to some embodiments of the subject invention. FIGS. 11A, 11B, and 11C contain foreign characters to illustrate the instant invention; and these foreign characters form no part of the instant invention.

FIGS. 12A, 12B, 12C, 12D, 12E, 12F, and 12G are a user interface according to some embodiments of the subject invention. FIGS. 12A, 12B, 12C, 12D, 12E, 12F, and 12G contain foreign characters to illustrate the instant invention; and these foreign characters form no part of the instant invention.

FIGS. 13A-1, 13A-2, 13B, 13C, 13D-1, 13D-2, 13E, and 13F are a root table according to some embodiments of the subject invention. FIGS. 13A-1, 13A-2, 13B, 13C, 13D-1, 13D-2, 13E, and 13F contain foreign characters to illustrate the instant invention; and these foreign characters form no part of the instant invention.

FIG. 14 is a method of inputting a character according to some embodiments of the subject invention.

FIG. 15 is a method of inputting a character according to some embodiments of the subject invention.

FIG. 16 is a method of inputting a character according to some embodiments of the subject invention.

FIG. 17 is a method of inputting a character according to some embodiments of the subject invention.

FIG. 18 is a method of indexing a character according to some embodiments of the subject invention.

FIG. 19 is a method of indexing a character according to some embodiments of the subject invention.

FIG. 20 is a method of indexing a character according to some embodiments of the subject invention.

### DETAILED DESCRIPTION

The following disclosure provides many different embodiments or examples for implementing different features of the provided subject matter. The following describes particular examples of components and deployments. Certainly, these are merely examples and are not intended to be limitative. In addition, in the subject invention, reference numerals and/or letters may be repeated in examples. This repetition is for the purpose of simplification and clarity, and does not indicate a relationship between the described various embodiments and/or configurations. Furthermore, the subject invention may use ordinal numbers such as first, second, and the like to distinguish similar components in each example. The above numbers are only used to distinguish the components labeled in this embodiment. However, the same numbers may label different components in different embodiments, or different numbers may label similar components.

The embodiments of the subject invention are described in detail below. However, it should be understood that, the subject invention provides many applicable concepts that can be implemented in various particular cases. The described particular embodiments are only illustrative and do not limit the scope of the subject invention.

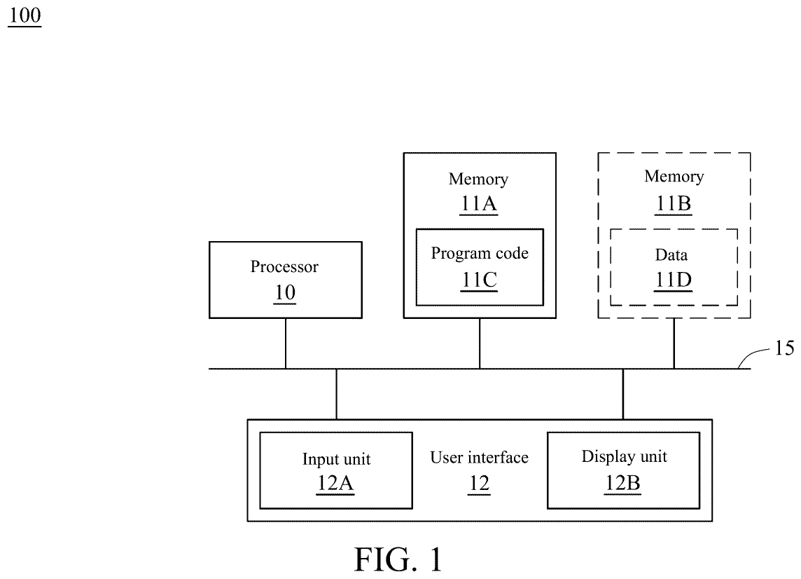

FIG. 1 is a schematic diagram of an electronic device 100 according to some embodiments of the subject invention. The electronic device 100 may include, but is not limited to, a mobile device (such as a phone, a watch, and a personal digital assistant), a tablet computer, a computer, or a point of sales (POS) machine.

The electronic device 100 includes a processor 10, a memory 11A, a memory 11B, a user interface 12, and a connection unit 15. For the electronic device 100, the memory 11B may be an optional component, i.e., the memory 11B may be included in the electronic device 100, or may be located in a remote device away from the electronic device 100. The user interface 12 may include an input unit 12A and a display unit 12B. The processor 10, the memory 11A, the memory 11B, and the user interface 12 (i.e., the input unit 12A and the display unit 12B) are communicatively connected to each other via the connection unit 15. Information, a signal, data, or a command may be transferred between the processor 10, the memory 11A, the memory 11B, and the user interface 12 (i.e., the input unit 12A and the display unit 12B). The connection unit 15 can be configured to provide a wired or wireless connection between the processor 10, the memory 11A, the memory 11B, and the user interface 12. The connection unit 15 may include, but is not limited to, a bus, an electronic circuit, a circuit board, an antenna, or a photonic integrated circuit.

The processor 10 can be configured to receive information, signals, data, or commands from the user interface 12. The processor 10 can be configured to receive information, signals, data, or commands from the input unit 12A. The processor 10 can be configured to transmit information, signals, data, or commands to the user interface 12. The processor 10 can be configured to transmit information, signals, data, or commands to the display unit 12B. In some embodiments, the processor 10 can be configured to receive a first signal from the input unit 12A, generate a second signal in response to the first signal, and transmit the second signal to the display unit 12B. The processor 10 can be configured to receive information, signals, data, commands, or program codes from the memory 11A. The processor 10 can be configured to transmit information, signals, data, or commands to the memory 11A. The processor 10 can be configured to receive information, signals, the data, commands, or program codes from the memory 11B. In some embodiments, the processor 10 can be configured to generate a third signal and transmit the third signal to the memory 11A. The memory 11A can be configured to transmit information, signals, data, commands, or program codes stored in the memory 11A to the processor 10 in response to the third signal. The processor 10 can be configured to transmit information, signals, data, or commands to the memory 11B. In some embodiments, the processor 10 can be configured to generate a fourth signal and transmit the fourth signal to the memory 11B. The memory 11B can be configured to transmit information, signals, data, commands, or program codes stored in the memory 11B to the processor 10 in response to the fourth signal. In some embodiments, the processor 10 may include a central processing unit (CPU), a graphics processing unit (GPU), an integrated circuit, a microprocessor, a cache, and the like. In some embodiments, the user interface 12 may include a graphical user interface, a touch screen, a keyboard, a mouse, a handle, a screen, a projector, and the like. In some embodiments, a user can provide information, signals, data, commands, or program codes to the electronic device 100 through the input unit 12A. The display unit 12B may display the information, signals, data, commands, or program codes in the form of images, text, audio, or video for the user to watch.

The memory 11A includes one or more blocks for storing the program code (or a computer program, or a computer program product) 11C. The memory 11A can be configured to transmit one or more commands in the program code 11C to the processor 10. The processor 10 can be configured to load one or more commands in the program code 11C to perform one or more steps. The processor 10 can be configured to load the program code 11C to perform one or more steps. The processor 10 can be configured to load the program code 11C to receive the command through the input unit 12A and/or to display data through the display unit 12B. In some embodiments, the program code 11C is used for inputting of a character and/or indexing of a character. The memory 11B includes one or more blocks for storing data 11D. The memory 11B can be configured to transfer some or all of the data 11D to the processor 10. The processor 10 can be configured to load one or more commands in the program code 11C to access some or all of the data 11D. The processor 10 can be configured to generate a command based on some or all of the received data 11D and transmit the command to the user interface 12 (for example, the display unit 12B). In some embodiments, the data 11D includes characters, such as traditional Chinese characters and their annotations, simplified Chinese characters and their annotations, and the like.

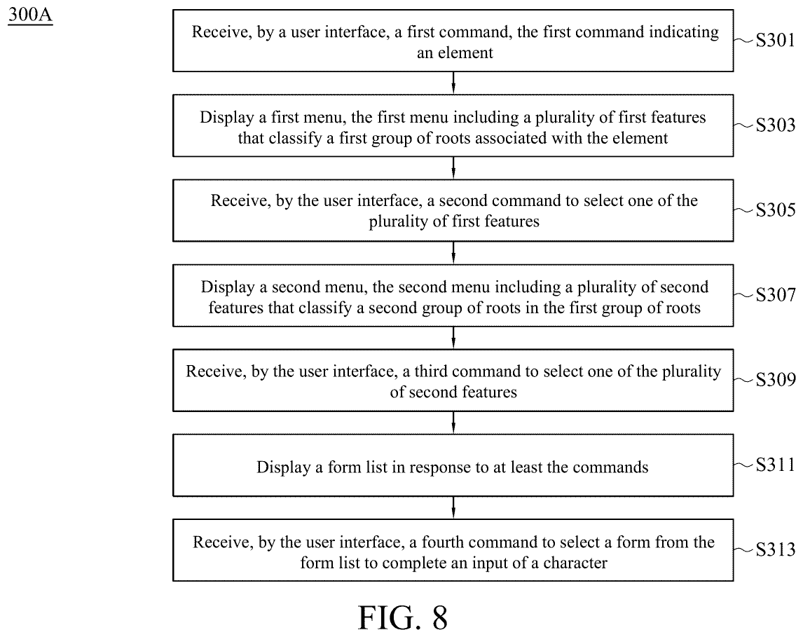

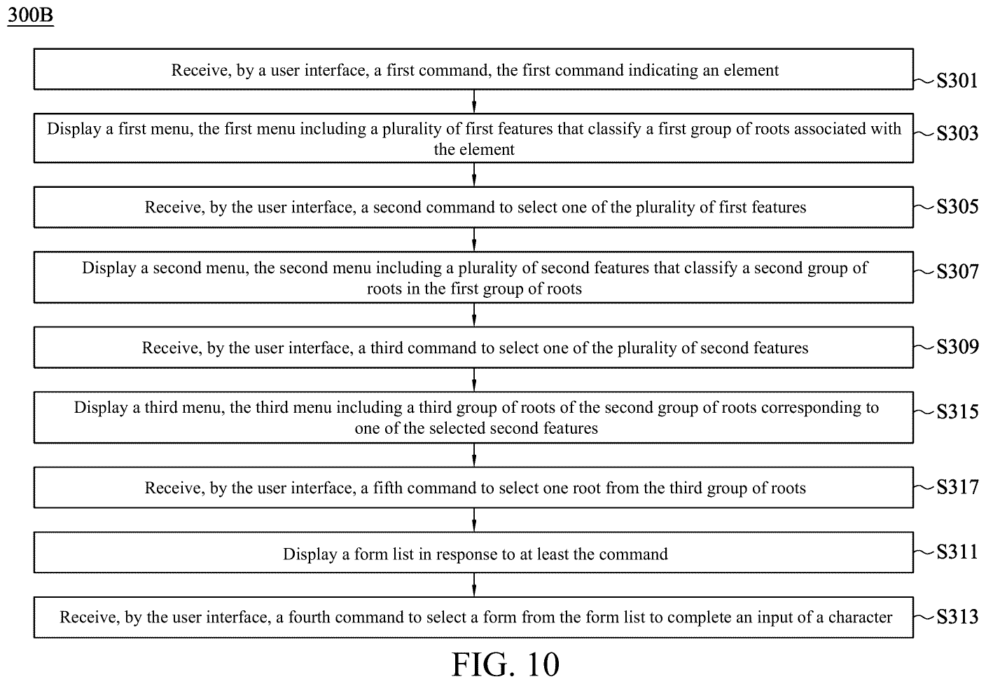

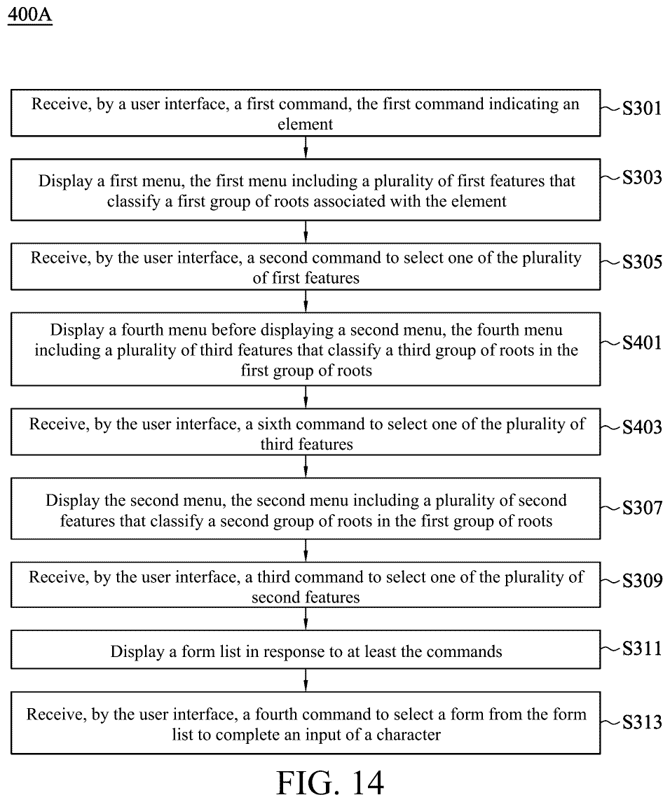

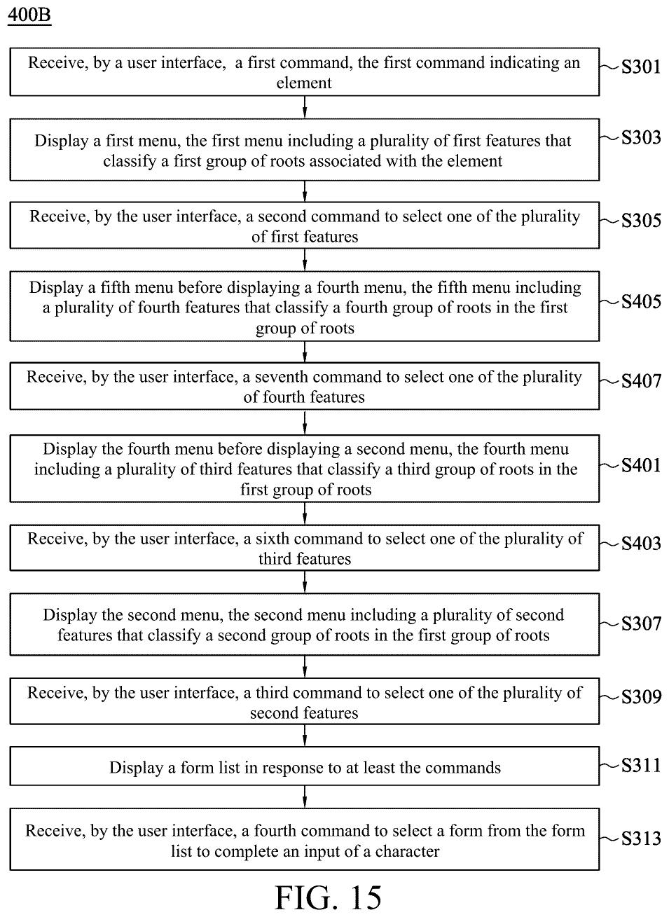

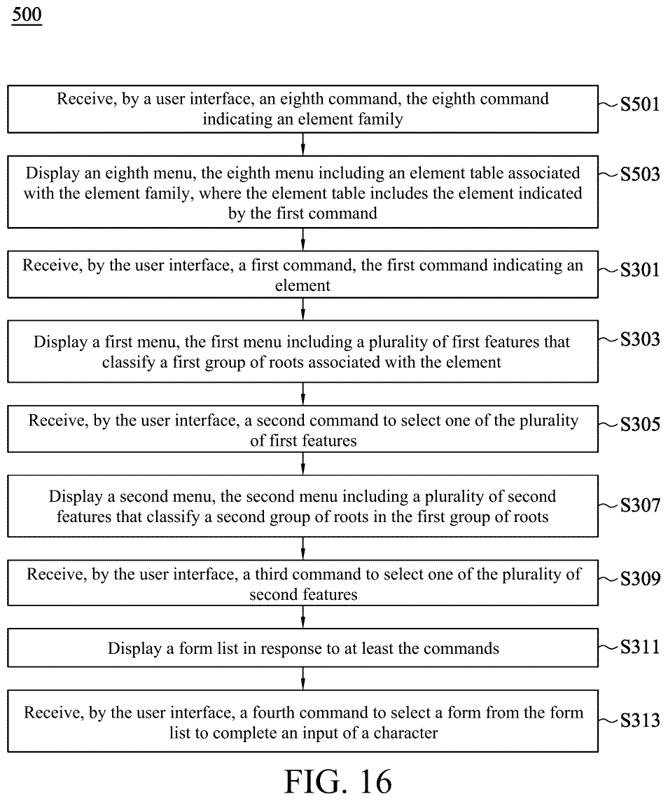

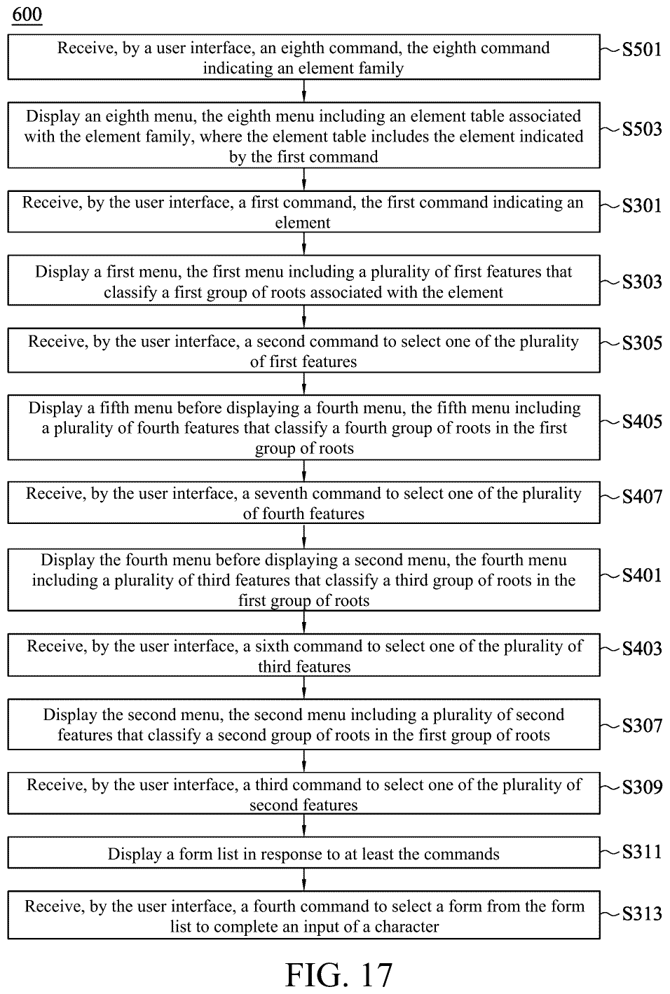

In some embodiments, the processor 10 of the electronic device 100 can be configured to execute one or more commands in the program code 11C stored in the memory 11A, and access the data 11D stored in the memory 11B according to the command to perform a method of inputting a character, for example, a method 300A of FIG. 8, a method 300B of FIG. 10, a method 400A of FIG. 14, a method 400B of FIG. 15, a method 500 of FIG. 16, or a method 600 of FIG. 17. For example, based on step S301, S305, S309, or S313, the electronic device 100 may receive the command through the input unit 12A of the user interface 12. For another example, based on step S303, S307, or S311, the processor 10 may control a picture displayed on the user interface 12 based on the command input from the user interface 12.

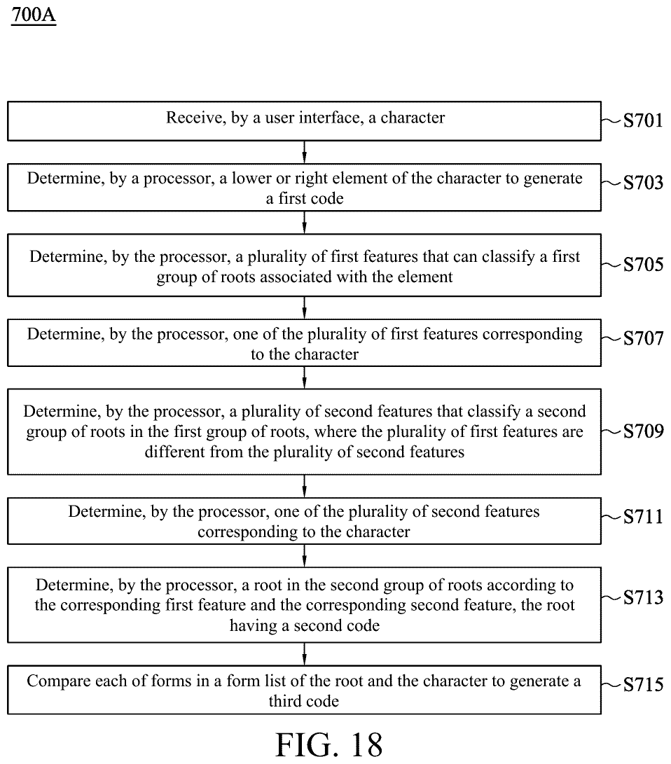

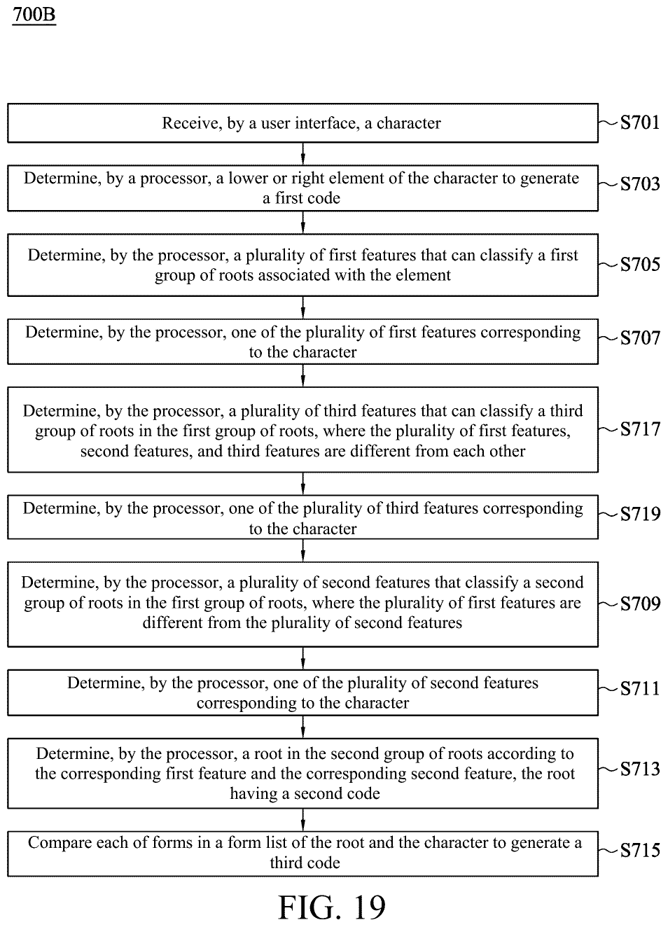

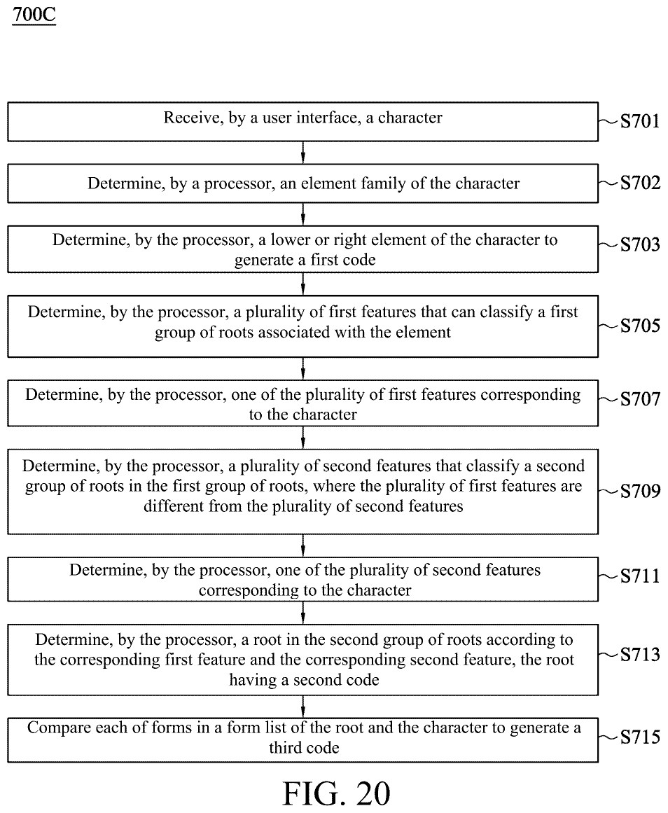

In some embodiments, the processor 10 of the electronic device 100 can be configured to execute one or more commands in the program code 11C stored in the memory 11A, and access the data 11D stored in the memory 11B according to the command to perform a method of indexing a character, for example: a method 700A of FIG. 18, a method 700B of FIG. 19, or a method 700C of FIG. 20. For example, based on step S701, the electronic device 100 may receive a character through the input unit 12A of the user interface 12. For example, the processor 10 can be configured to execute one or more commands in the program code 11C stored in the memory 11A to perform step S703, S705, S707, S709, S711, S713, or S715.

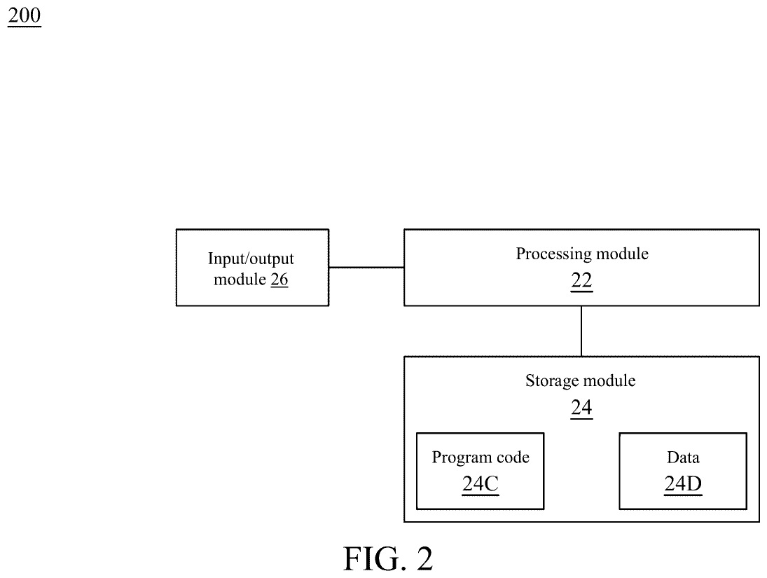

FIG. 2 is a schematic diagram of a system 200 according to some embodiments of the subject invention. The system 200 includes a processing module 22, a storage module 24, and an input/output module 26. The input/output module 26 is connected to the processing module 22. In some embodiments, the input/output module 26 is communicatively connected (via wireless communication) or physically connected (for example, via a circuit) to the processing module 22. The storage module 24 is connected to the processing module 22. In some embodiments, the storage module 24 is communicatively connected or physically connected (for example, via a circuit) to the processing module 22. In some embodiments, the processing module 22, the storage module 24, and the input/output module 26 are included in a cloud server. In some embodiments, the system 200 includes a physical server, a cloud server, and the like.

The processing module 22 can be configured to receive information, signals, data, or commands from the input/output module 26. The processing module 22 can be configured to transmit information, signals, data, or commands to the input/output module 26. In some embodiments, the processing module 22 can be configured to receive a first command from the input/output module 26, generate a second command in response to the first command, and transmit the second command to the input/output module 26. The processing module 22 can be configured to receive information, signals, data, commands, or program codes from the storage module 24. The processing module 22 can be configured to transmit information, signals, data, or commands to the storage module 24. In some embodiments, the processing module 22 can be configured to generate and transmit a third command to the storage module 24. The storage module 24 can be configured to transmit information, signals, data, commands, or program codes stored in the storage module 24 to the processing module 22 in response to the third command In some embodiments, the processing module 22 may include a central processing unit (CPU), a graphics processing unit (GPU), an integrated circuit, a microprocessor, a cache, and the like. In some embodiments, a remote user of the system 200 may provide information, signals, data, commands, or program codes to the system 200 through the input/output module 26. The input/output module 26 may also transmit information, signals, data, commands, or program codes to the electronic device of the remote user of the system 200, so that the electronic device may display the received information, signals, data, commands, or program codes in the form of images, text, audio, or video for the user to watch.

The storage module 24 includes one or more blocks for storing program code (or a computer program, or a computer program product) 24C. The storage module 24 can be configured to transmit one or more commands in the program code 24C to the processing module 22. The processing module 22 can be configured to load one or more commands in the program code 24C to perform one or more steps. The processing module 22 can be configured to load the program code 24C to perform one or more steps. The processing module 22 can be configured to load the program code 24C to receive a command through the input/output module 26 and/or to output a command or data through the input/output module 26. In some embodiments, the program code 24C is used for inputting of a character and/or indexing of a character. The storage module 24 includes one or more blocks for storing data 24D. The storage module 24 can be configured to transfer some or all of the data 24D to the processing module 22. The processing module 22 can be configured to load one or more commands in the program code 24C to access some or all of the data 24D. The processing module 22 can be configured to generate a command based on some or all of the received data 24D and transmit the command to the input/output module 26. In some embodiments, the data 24D includes characters, such as traditional Chinese characters and their annotations, simplified Chinese characters and their annotations, and the like.

In some embodiments, the processing module 22 of the system 200 can be configured to execute one or more commands in the program code 24C stored in the storage module 24 and access the data 24D to perform a method of inputting a character, for example: a method 300A of FIG. 8, a method 300B of FIG. 10, a method 400A of FIG. 14, a method 400B of FIG. 15, a method 500 of FIG. 16, or a method 600 of FIG. 17. For example, based on step S301, S305, S309, or S313, the system 200 may receive the command through the input/output module 26. For another example, based on step S303, S307, or S311, the system 200 may transmit information, signals, data, commands, or program codes to the electronic device of the remote user through the input/output module 26 to display a picture.

In some embodiments, the processing module 22 of the system 200 can be configured to execute one or more commands in the program code 24C stored in the storage module 24 and access the data 24D to perform a method of indexing a character, for example: a method 700A of FIG. 18, a method 700B of FIG. 19, or a method 700C of FIG. 20. For example, based on step S701, the system 200 may receive the command through the input/output module 26. The processing module 22 can be configured to execute one or more commands in the program code 24C stored in the storage module 24 to perform step S703, S705, S707, S709, S711, S713, or S715.

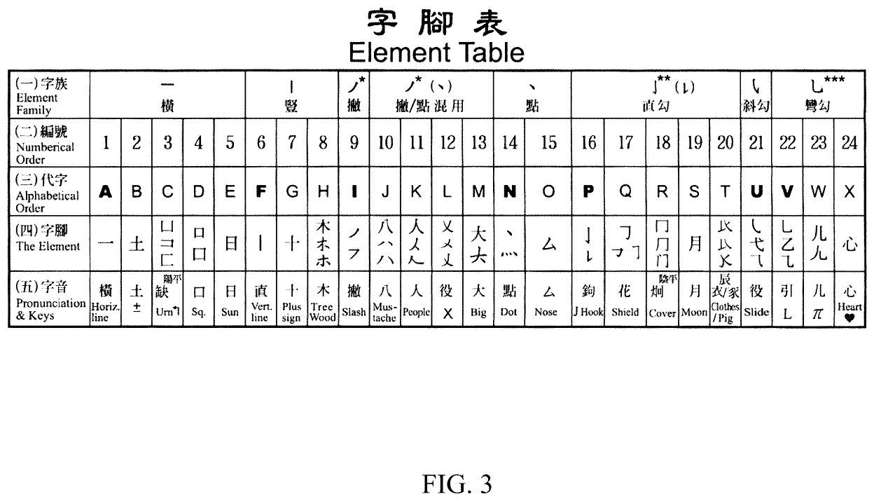

FIG. 3 is an element table according to some embodiments of the subject invention. As shown in FIG. 3, a first column of the element table includes an element family, which includes seven types: such as [symbol] (horizontal stroke)”, [symbol] (vertical stroke)”, [symbol] (left-falling stroke)”, “' (dot stroke)”, [symbol] (vertical-hook stroke)”, [symbol] (slant-hook stroke)”, and [symbol] (bend-hook stroke)”. The element family (seven strokes) in the embodiment of FIG. 3 is summarized from 32 basic strokes of Chinese characters, as shown in Table 1 below. This paragraph and Table 1 contain foreign characters to illustrate the instant invention; and these foreign characters form no part of the instant invention.

TABLE 1 [symbol]
Basic Strokes

| [symbol] | [symbol] | [symbol] | [symbol] |
|---|---|---|---|
| 1 | [symbol] | [symbol] | [symbol] |
| 2 | [symbol] | [symbol] | [symbol] |
| 3 | [symbol] | [symbol] | [symbol] |
| 4 | [symbol] | [symbol] | [symbol] |
| 5 | [symbol] | [symbol] | [symbol] |
| 6 | [symbol] | [symbol] | [symbol] |
| 7 | [symbol] | [symbol] | [symbol] |
| 8 | [symbol] | [symbol] | [symbol] |
| 9 | [symbol] | [symbol] | [symbol] |
| 10 | [symbol] | [symbol] | [symbol] |
| 11 | [symbol] | [symbol] | [symbol] |
| 12 | [symbol] | [symbol] | [symbol] |
| 13 | [symbol] | [symbol] | [symbol] |
| 14 | [symbol] | [symbol] | [symbol] |
| 15 | [symbol] | [symbol] | [symbol] |
| 16 | [symbol] | [symbol] | [symbol] |
| [symbol] | [symbol] | [symbol] | [symbol] |
| 17 | [symbol] | [symbol] | [symbol] |
| 18 | [symbol] | [symbol] | [symbol] |
| 19 | [symbol] | [symbol] | [symbol] |
| 20 | [symbol] | [symbol] | [symbol] |
| 21 | [symbol] | [symbol] | [symbol] |
| 22 | [symbol] | [symbol] | [symbol] |
| 23 | [symbol] | [symbol] | [symbol] |
| 24 | [symbol] | [symbol] | [symbol] |
| 25 | [symbol] | [symbol] | [symbol] |
| 26 | [symbol] | [symbol] | [symbol] |
| 27 | [symbol] | [symbol] | [symbol] |
| 28 | [symbol] | [symbol] | [symbol] |
| 29 | [symbol] | [symbol] | [symbol] |
| 30 | [symbol] | [symbol] | [symbol] |
| 31 | [symbol] | [symbol] | [symbol] |
| 32 | [symbol] | [symbol] | [symbol] |

In some embodiments, the element family is a single stroke of the character at the lower right or bottom. Taking a Chinese character [symbol] (Spring)” as an example, it can be divided by a nine-square grid to obtain one or more squares at the lower right, such as squares 1, 2, and 3 as shown in Table 2 below. As can be seen from the squares 1, 2, and 3, a single stroke at the bottom of the Chinese character [symbol] (Spring)” at the lower right or bottom is [symbol] (horizontal stroke)”. Therefore, the Chinese character [symbol] (Spring)” belongs to the element family [symbol] (horizontal stroke)”. This paragraph and Table 2 contain foreign characters to illustrate the instant invention; and these foreign characters form no part of the instant invention.

In some embodiments, for other languages such as Japanese, Korean, Egyptian, English, and the like, dedicated element families can be defined according to their features. For example, according to different languages, an element family associated with the language can be summarized according to a rule similar to “the element family is a single stroke of the character at the lower right or bottom”. However, this example is only for description and is not intended to limit the subject invention.

Returning to FIG. 3, each element family includes an associated element thereof, as shown in a fourth column The element family is one stroke and the element does not exceed four strokes. The element is a font with less than four strokes deriving upward from the respective element family As shown in Table 2, the element with less than four strokes deriving upward from the element family [symbol] (horizontal stroke)” in the Chinese character font [symbol] (Spring)” is [symbol] (sun)”. This paragraph contains foreign characters to illustrate the instant invention; and these foreign characters form no part of the instant invention.

In some embodiments, the element family [symbol] (horizontal stroke)” may correspond to the following elements: [symbol] (horizontal stroke)” (number: 1/code: A/pronunciation: heng); [symbol] (soil)” (number: 2/code: B/pronunciation: tu); [symbol] , and [symbol] (number: 3/code: C/pronunciation: que^{raising tone}, fang, kan); [symbol] (mouth)” (number: 4/code: D/pronunciation: kou); and [symbol] (sun)” (number: 5/code: E/pronunciation: ri). This paragraph contains foreign characters to illustrate the instant invention; and these foreign characters form no part of the instant invention.

In some embodiments, the element family [symbol] (vertical stroke)” may correspond to the following elements: [symbol] (vertical stroke)” (number: 6/code: F/pronunciation: zhi); [symbol] (ten)” (number: 7/code: G/pronunciation: shi); and [symbol] , and [symbol] (number: 8/code: H/pronunciation: mu). This paragraph contains foreign characters to illustrate the instant invention; and these foreign characters form no part of the instant invention.

In some embodiments, the element family [symbol] (left-falling stroke)” may correspond to the following elements: [symbol] (left-falling stroke)” and [symbol] (number: 9/code: I/pronunciation: pie); [symbol] , and [symbol] (number: 10/code: J/pronunciation: ba); [symbol] , [symbol] , and [symbol] (number: 11/code: K/pronunciation: ren); [symbol] , and [symbol] (number: 12/code: L/pronunciation: yi); and [symbol] and [symbol] (number: 13/code: M/pronunciation: da). In some embodiments, the element codes J, K, L, and M are mixed by the element families [symbol] (left-falling stroke)” and “' (dot stroke)”. This paragraph contains foreign characters to illustrate the instant invention; and these foreign characters form no part of the instant invention.

In some embodiments, the element family “' (dot stroke)” may correspond to the following elements: “' (dot stroke)” and [symbol] (number: 14/code: N/pronunciation: dot); and [symbol] (number: 15/code: O/pronunciation: se). This paragraph contains foreign characters to illustrate the instant invention; and these foreign characters form no part of the instant invention.

In some embodiments, the element family [symbol] (vertical-hook stroke)” may correspond to the following elements: [symbol] (vertical-hook stroke)” and [symbol] (number: 16/code: P/pronunciation: gou); [symbol] and [symbol] (number: 17/code: Q/pronunciation: hua); [symbol] , [symbol] and [symbol] (number: 18/code: R/pronunciation: jiong^{Yinping}); [symbol] (number: 19/code: S/pronunciation: yue); and [symbol] , and [symbol] (number: 20/code: T/pronunciation: chen, yi, and shi). This paragraph contains foreign characters to illustrate the instant invention; and these foreign characters form no part of the instant invention.

In some embodiments, the element family [symbol] (slant-hook stroke)” may correspond to the following elements: [symbol] (slant-hook stroke)”, [symbol] , and [symbol] (number: 21/code: U/pronunciation: yi). This paragraph contains foreign characters to illustrate the instant invention; and these foreign characters form no part of the instant invention.

In some embodiments, the element family [symbol] (bend-hook stroke)” may correspond to the following elements: [symbol] (bend-hook stroke)”, [symbol] (second)”, and [symbol] (number: 22/code: V/pronunciation: yin); [symbol] (son)” and [symbol] (number: 23/code: W/pronunciation: er); and [symbol] (heart)” (number: 24/code: X/pronunciation: xin). This paragraph contains foreign characters to illustrate the instant invention; and these foreign characters form no part of the instant invention.

Since some elements belong to the special classification of fonts of the subject invention, it is difficult to fully present them in this specification. The fonts and shapes of the foregoing elements and the foregoing element families are all in regular script. Some special characters may be presented in the form of imitation Song script, printed script, or the like. In addition, the subject invention is applicable to traditional Chinese characters and simplified Chinese characters. Therefore, the fonts used by the element may include “common Chinese characters”.

Each element in FIG. 3 has an associated root table, which includes a plurality of roots. The root described in this application is formed by adding strokes to the element “from bottom to top, or from outside to inside”. More than 80% of Chinese characters are pictophonetic or phono-semantic characters, i.e., they have a shape part and a voice part. Their combinations can be divided into top and bottom, left and right, inside and outside, or the like. The subject invention can adopt an initial character (a right half part of a left and right pictophonetic character, a lower half part or full shape of an upper and lower pictophonetic character, a full shape of an inner and outer pictophonetic character) as the root. The root is the most important and basic unit that constitutes a Chinese character. A relatively unchanged structure formed by cross-connection of several strokes is referred to as a root.

In some embodiments, the root table described in this application can be arranged through the following operations:

(1) First classify and group groups according to glyph features, for example: positional features: next to/below; glyph features: wide/narrow, obvious/hidden in the root, large/small, symmetrical/asymmetrical, and the like; stroke features: strokes intersecting/joining, same height/different height, same number of strokes such as one stroke, two strokes, and the like.

(2) Then according to the stroke combinations added above or to the left of the element, the single strokes at the bottom and lower right corner are arranged in the order of the element family (i.e., in an order of [symbol] (horizontal stroke)”, [symbol] (vertical stroke)”, [symbol] (left-falling stroke)”, “' (dot stroke)”, [symbol] (vertical-hook stroke)”, [symbol] (slant-hook stroke)”, and [symbol] (bend-hook stroke)”), and one or more groups of roots (or sub-groups of roots) are classified, for example: A first sub-group of roots may be a trickle of forms, i.e., those whose roots have only a single glyph, or only two or three forms. This paragraph contains foreign characters to illustrate the instant invention; and these foreign characters form no part of the instant invention.

If there are too many roots to be selected, in order to avoid selecting from too many roots which is overly time-consuming, the foregoing operation (1) or (2) can be repeated for a plurality of classifications. In this way, the number of sub-groups increases, and the number of roots that can be selected each time also decreases. The number of repetitions (or levels) of the foregoing operation (1) or (2) is controlled within a predetermined value to achieve a balance between the number of repetitions (or levels) and the number of selectable roots. A larger number of repetitions (or levels) can reduce the difficulty of selection for a beginner, while a smaller number of repetitions can increase the speed of inputting of a character.

The way of arranging the root table in the present disclosure is not limited to this embodiment. In other words, the number or order of performing operation (1) and operation (2) can be adjusted depending on the situation, for example: operation (1) can be performed multiple times and then operation (2) is performed, or operation (1) and operation (2) are performed and then operation (1) is performed again.

According to some embodiments of this application, a predetermined value may be used as an upper limit of the number of roots that can be selected at a time. For example, if the number of selectable roots exceeds the predetermined value, the foregoing operation (1) or (2) needs to be performed again to further classify the selectable roots. The size of the predetermined value may be a fixed value, or may be determined by the size of a display interface of the electronic device performing the method of inputting a character. For example, a display screen of a mobile phone is generally small, and the predetermined value may be 8; and a display screen of a personal computer is generally large, and the predetermined value may be 15.

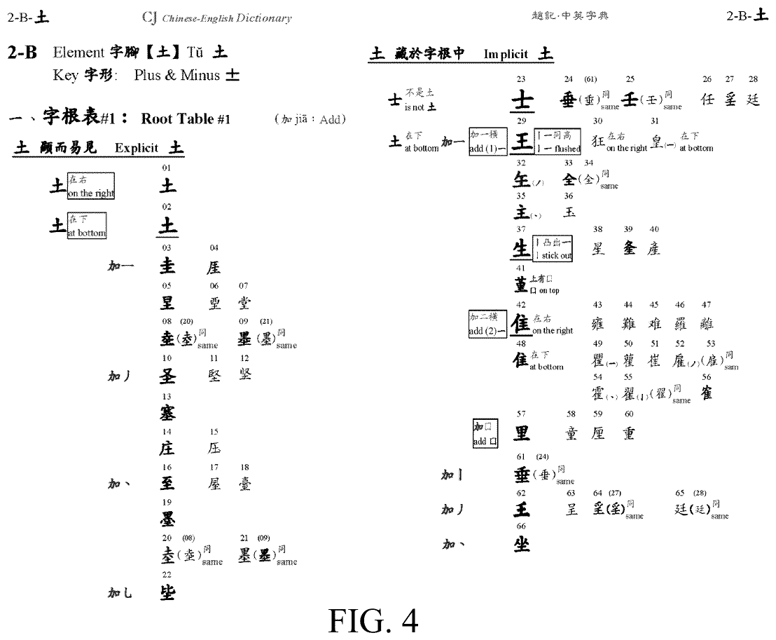

The following uses FIG. 4 to illustrate a root table associated with the element “ [symbol] (soil)” (code: B) according to some embodiments of the subject invention. As shown in FIG. 4, the root table of the element “ [symbol] (soil)” is arranged in ascending order. A group of roots of the element “ [symbol] (soil)” includes roots “ [symbol] (soil)” (root code: 01), [symbol] (gui)” (root code: 03), . . . , and [symbol] (sit)” (root code 66). In this application, the roots of the element “ [symbol] (soil)” are classified and grouped through the foregoing operations (1) and (2). As shown in FIG. 4, in a first level of classification, the group of roots of the element “ [symbol] (soil)” is classified according to the feature “obvious/hidden in the root”, to generate a group of roots (or sub-group of roots) of the element “ [symbol] (soil)” that has the feature “obvious” (roots 01-22 in FIG. 4) and a group of roots (or sub-group of roots) of the element “ [symbol] (soil)” that has the feature “hidden in the root” (roots 23-66 in FIG. 4). This paragraph contains foreign characters to illustrate the instant invention; and these foreign characters form no part of the instant invention.

In a second level of classification, the group of roots of the element “ [symbol] (soil)” with the feature “obvious” is classified according to the feature “next to/below”, to generate a group of roots of the element “ [symbol] (soil)” that has the feature “on the right” (a root 01 in FIG. 4) and a group of roots of the element “ [symbol] (soil)” that has the feature “at the bottom” (roots 02-22 in FIG. 4). This paragraph contains foreign characters to illustrate the instant invention; and these foreign characters form no part of the instant invention.

Since the number of roots in the group of roots (or sub-group of roots) of the element “ [symbol] (soil)” with the features “obvious” and “on the right” is less than the predetermined value, for example, only one root “ [symbol] (soil)” is included, there is no next-level classification. In a third level of classification, the group of roots (or sub-group of roots) of the element “ [symbol] (soil)” with the features “obvious” and “at the bottom” is classified according to the feature “a single stroke in the bottom or lower right corner except the element” and arranged in the order of the element family (i.e., in the order of [symbol] (horizontal stroke)”, [symbol] (vertical stroke)”, [symbol] (left-falling stroke)”, “' (dot stroke)”, [symbol] (vertical-hook stroke)”, [symbol] (slant-hook stroke)”, and [symbol] (bend-hook stroke)”), to generate a group of roots of the element [symbol] (soil)” with the feature “adding [symbol] (horizontal stroke)” (i.e., the addition of a stroke [symbol] (horizontal stroke)”) (i.e., roots 03 to 09 in FIG. 4), a group of roots of the element [symbol] (soil)” with the feature “adding [symbol] (left-falling stroke)” (i.e., the addition of a stroke “ [symbol] (left-falling stroke)”) (i.e., roots 10 to 15 in FIG. 4), a group of roots of the element [symbol] (soil)” with the feature “adding ' (dot stroke)” (i.e., the addition of a stroke “' (dot stroke)”) (i.e., roots 16 to 21 in FIG. 4), and a group of roots of the element [symbol] (soil)” with the feature “adding [symbol] (bend-hook stroke)” (i.e., the addition of a stroke [symbol] (bend-hook stroke)”) (i.e., a root 22 in FIG. 4). The group of roots of the element [symbol] (soil)” with the features “obvious”, “at the bottom”, and “adding [symbol] (horizontal stroke)” include: a main root [symbol] (gui)” and its subordinate root [symbol] (ya)”; a main root [symbol] and its subordinate roots [symbol] and [symbol] ; and a main root [symbol] and its subordinate roots [symbol] and [symbol] . The main root is a main prototype derived by adding strokes to the element, i.e., a combination of the same or similar parts of its subordinate roots, also referred to as a “common denominator”. In the root table in publications related to this application, the main root is shown in an enlarged and bold font. This paragraph contains foreign characters to illustrate the instant invention; and these foreign characters form no part of the instant invention.

Since the number of roots in the group of roots of the element [symbol] (soil)” with the features “obvious”, “at the bottom”, and “adding [symbol] (horizontal stroke)” is less than a predetermined value, there is no next-level classification. Since the number of roots in the group of roots of the element [symbol] (soil)” with the features “obvious”, “at the bottom”, and “adding [symbol] (left-falling stroke)” is less than a predetermined value, there is no next-level classification. Since the number of roots in the group of roots of the element [symbol] (soil)” with the features “obvious”, “at the bottom”, and “adding ' (dot stroke)” is less than a predetermined value, there is no next-level classification. Since the number of roots in the group of roots of the element [symbol] (soil)” with the features “obvious”, “at the bottom”, and “adding [symbol] (bend-hook stroke)” is less than a predetermined value, there is no next-level classification. This paragraph contains foreign characters to illustrate the instant invention; and these foreign characters form no part of the instant invention.

In the second level of classification, a group of roots of the element [symbol] (soil)” with the feature “hidden in the root” is classified according to the features “change” and “next to/below”, to generate a group of roots of the element [symbol] (soil)” with the feature “not [symbol] (soil)” (i.e. [symbol] ”) and a group of roots of the element [symbol] (soil)” with the feature “at the bottom”. This paragraph contains foreign characters to illustrate the instant invention; and these foreign characters form no part of the instant invention.

Since the number of roots in the group of roots of the element [symbol] (soil)” with the features “hidden in the root” and “not [symbol] (soil)” is less than a predetermined value, there is no next-level classification. In the third level of classification, a group of roots of the element [symbol] (soil)” with the features “hidden in the root” and “at the bottom” is classified according to the feature “a single stroke in the bottom or lower right corner except the element”, to generate a group of roots of the element [symbol] (soil)” with the feature “adding [symbol] (horizontal stroke)” (i.e., the addition of a stroke [symbol] (horizontal stroke)”), a group of roots of the element [symbol] (soil)” with the feature “adding [symbol] (vertical stroke)” (i.e., the addition of a stroke [symbol] (vertical stroke)”), a group of roots of the element [symbol] (soil)” with the feature “adding [symbol] (left-falling stroke)” (i.e., the addition of a stroke [symbol] (left-falling stroke)”), and a group of roots of the element [symbol] (soil)” with the feature “adding ' (dot stroke)” (i.e., the addition of a stroke “' (dot stroke)”). This paragraph contains foreign characters to illustrate the instant invention; and these foreign characters form no part of the instant invention.

Since the number of roots in the group of roots of the element [symbol] (soil)” with the features “hidden in the root”, “at the bottom”, and “adding [symbol] (vertical stroke)” is less than a predetermined value, there is no next-level classification. Since the number of roots in the group of roots of the element [symbol] (soil)” with the features “hidden in the root”, “at the bottom”, and “adding [symbol] (left-falling stroke)” is less than a predetermined value, there is no next-level classification. Since the number of roots in the group of roots of the element [symbol] (soil)” with the features “hidden in the root”, “at the bottom”, and “adding ' (dot stroke)” is less than a predetermined value, there is no next-level classification. This paragraph contains foreign characters to illustrate the instant invention; and these foreign characters form no part of the instant invention.

In a fourth level of classification, a group of roots of the element [symbol] (soil)” with the features “hidden in the root”, “at the bottom”, and “adding [symbol] (horizontal stroke)” is classified according to the feature “the number of strokes”, to generate a group of roots of the element [symbol] (soil)” with the feature “adding [symbol] (horizontal stroke)”, a group of roots of the element [symbol] (soil)” with the feature “adding two [symbol] (horizontal stroke)”, and a group of roots of the element [symbol] (soil)” with the feature “adding [symbol] (mouth)”. Since the number of roots in the group of roots of the element [symbol] (soil)” with the features “hidden in the root”, “at the bottom”, “adding [symbol] (horizontal stroke)”, and “adding [symbol] (mouth)” is less than a predetermined value, there is no next-level classification. This paragraph contains foreign characters to illustrate the instant invention; and these foreign characters form no part of the instant invention.

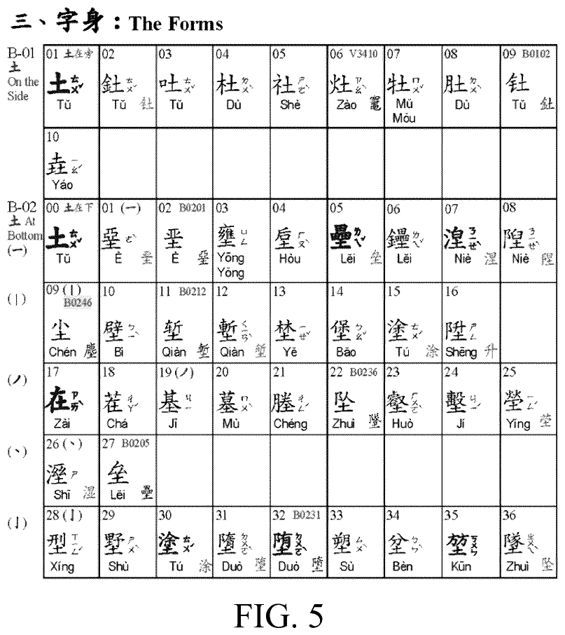

FIG. 5 is a form indexing according to some embodiments of the subject invention. FIG. 5 describes the form indexing associated with the root [symbol] (soil)”. For example, the form indexing associated with the root [symbol] (soil)” (number: B-01, which is a combination of an element code and a root code) with features “obvious” and “on the right” includes a plurality of forms. Some forms include forms [symbol] (soil)”, [symbol] (thorium)”, [symbol] (vomit)”, [symbol] (du)”, [symbol] (society)”, [symbol] (male bird or beast)”, [symbol] (kitchen range)”, [symbol] (belly)”, [symbol] (thorium)”, and [symbol] (yao)”. Taking the form [symbol] (soil)” as an example, an upper left corner of the form of the form [symbol] (soil)” is a two-digit number of the character (such as “01”). If it is a simplified character, the code of the related traditional Chinese character is listed next to the code on the upper right corner. For example, a form of the form [symbol] (kitchen range)” includes the code of the related traditional Chinese character “V3410”. The form of the form [symbol] (soil)” includes phonetic notation and pinyin of the form. In some embodiments, the user interface 12 of the electronic device 100 may display a form indexing, where the form may include an icon for driving a sound function for the user to click. This paragraph contains foreign characters to illustrate the instant invention; and these foreign characters form no part of the instant invention.

Based on the form indexing, each character has a specific code. Each character has a unique five-digit code including letters and numerals, or a six-digit code including numerals, which is associated with the character. For example, the form [symbol] (thorium)” has a code: B-01-02, which is a combination of an element code, a root code, and a form number. The user can quickly search or enter a character through a code. This paragraph contains foreign characters to illustrate the instant invention; and these foreign characters form no part of the instant invention.

In this embodiment of this application, the form indexing may be sorted in the order of the element families “horizontal stroke, vertical stroke, left-falling stroke, dot, and hook”. The form indexing may include one or more sub-groups. As shown in FIG. 5, the form indexing may include a sub-group of the root [symbol] (soil)” (number: B-01), which may include one or more forms. The forms of the entire sub-group may be sorted in the order of the element families “horizontal stroke, vertical stroke, left-falling stroke, dot, and hook”. This paragraph contains foreign characters to illustrate the instant invention; and these foreign characters form no part of the instant invention.

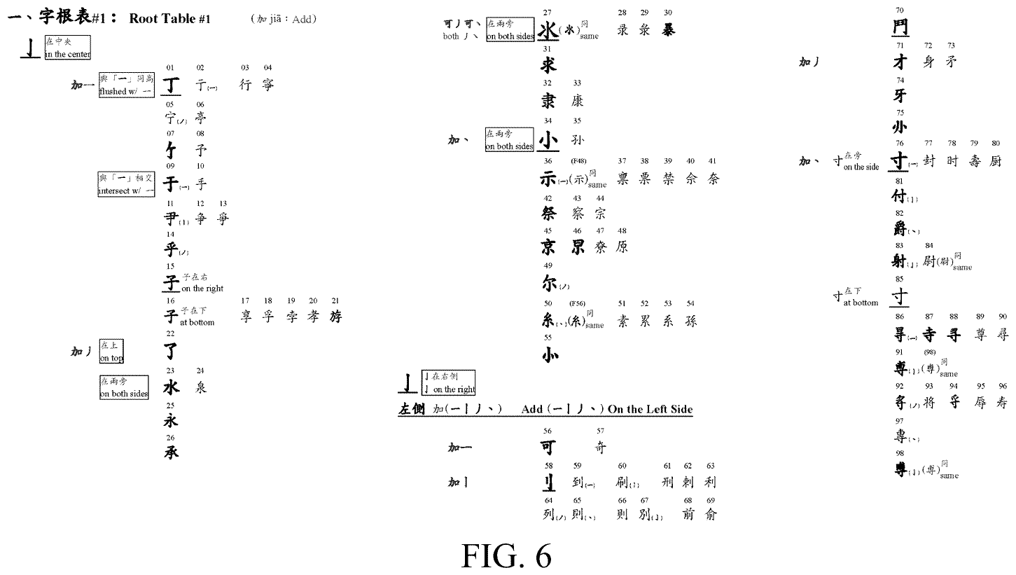

FIG. 6 is a root table according to some embodiments of the subject invention. The root table is a root table associated with the element [symbol] (vertical-hook stroke)” (code: P). As shown in FIG. 6, the root table of the element [symbol] (vertical-hook stroke)” is arranged in ascending order. A group of roots of the element [symbol] (vertical-hook stroke)” includes roots [symbol] (man)” (root code: 01), [symbol] (row)” (root code: 03), . . . , and [symbol] (fu)” (root code 91). In this application, the roots of the element [symbol] (vertical-hook stroke)” are classified and grouped through the foregoing operations (1) and (2). This paragraph contains foreign characters to illustrate the instant invention; and these foreign characters form no part of the instant invention.

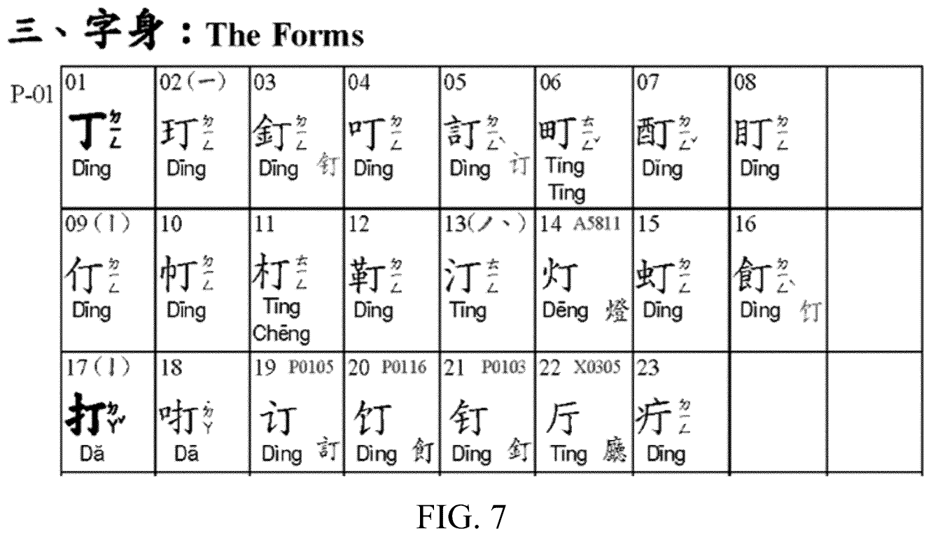

FIG. 7 is a form indexing associated with the root [symbol] (man)” according to some embodiments of the subject invention. The root [symbol] (man)” has a code: P-01, which is a combination of an element code and a root code. Forms associated with the root [symbol] (man)” include [symbol] (man)” (number: 01), [symbol] (ding)” (number: 02), . . . , [symbol] (ding)” (number: 23), and the like. Based on the form indexing, each character has a specific code. For example, the form [symbol] (ding)” has a code: P-01-02, which is a combination of an element code, a root code, and a form number. The user can quickly search dictionaries or other related products through code, or the users can input a character through the code. This paragraph contains foreign characters to illustrate the instant invention; and these foreign characters form no part of the instant invention.

The multi-level method of inputting a character of the subject invention may at least include the following:
(a) inputting, by a user interface or an input/output module, a first command to select one of a plurality of elements;
(b) inputting, by the user interface or the input/output module, an N^{th} command, where N is a positive integer greater than or equal to 2, to select one of a plurality of (N−1)^{th} (N minus 1) features (or an (N−1)^{th} group of root features) in an (N−1)^{th} menu, which corresponds to an (N−1)^{th} group of roots, and displaying, by the user interface or the input/output module, an N^{th} menu including the (N−1)^{th} group of roots, where the (N−1)^{th} group of root is included in the second group of roots;
(c) inputting, by the user interface or the input/output module, an (N+1)^{th} command to select one of the (N−1)^{th} group of roots in an N^{th} menu, and displaying, by the user interface or the input/output module, an (N+1)^{th} (N plus 1) menu including a form list corresponding to the selected root; and/or
(d) inputting, by the user interface or the input/output module, an (N+2)^{th} command to select one of the form list of the (N+1)^{th} menu to complete an input of a character.

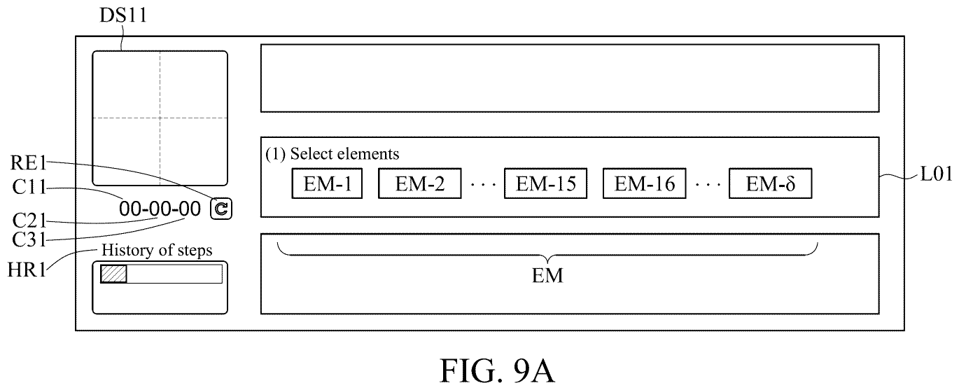

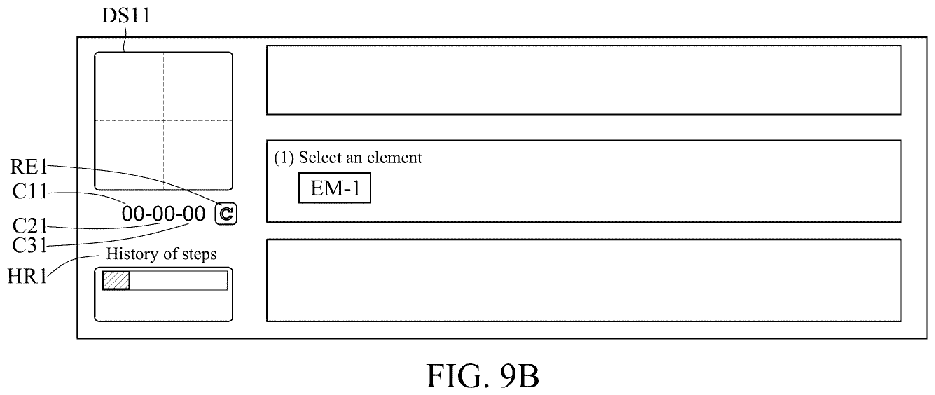

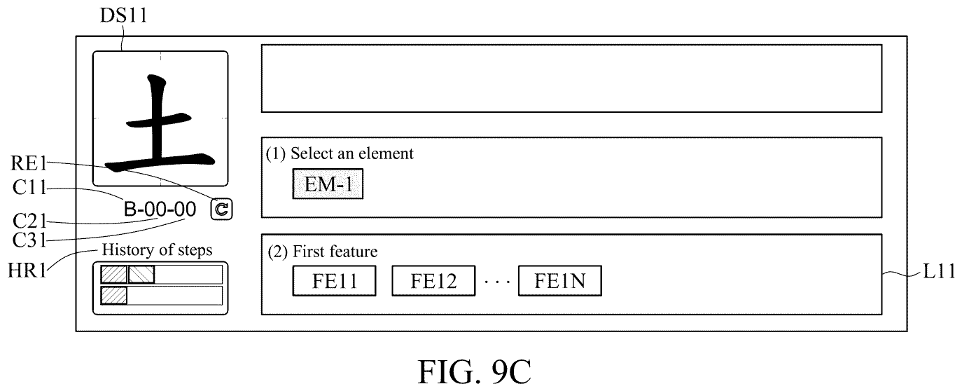

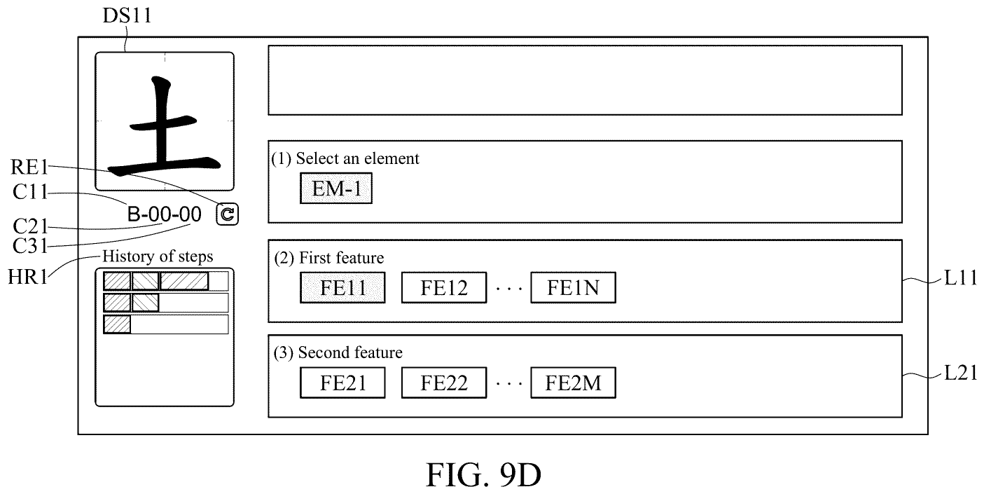

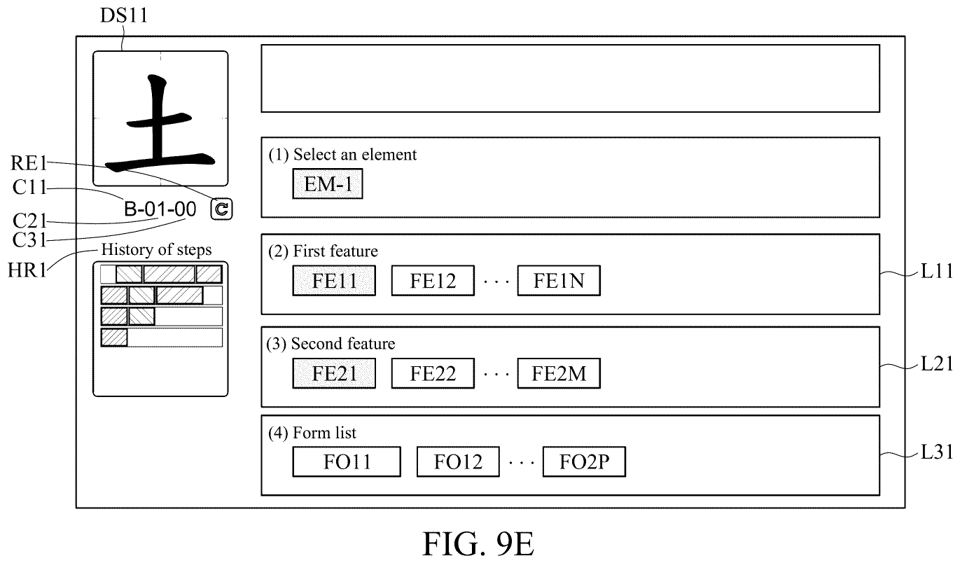

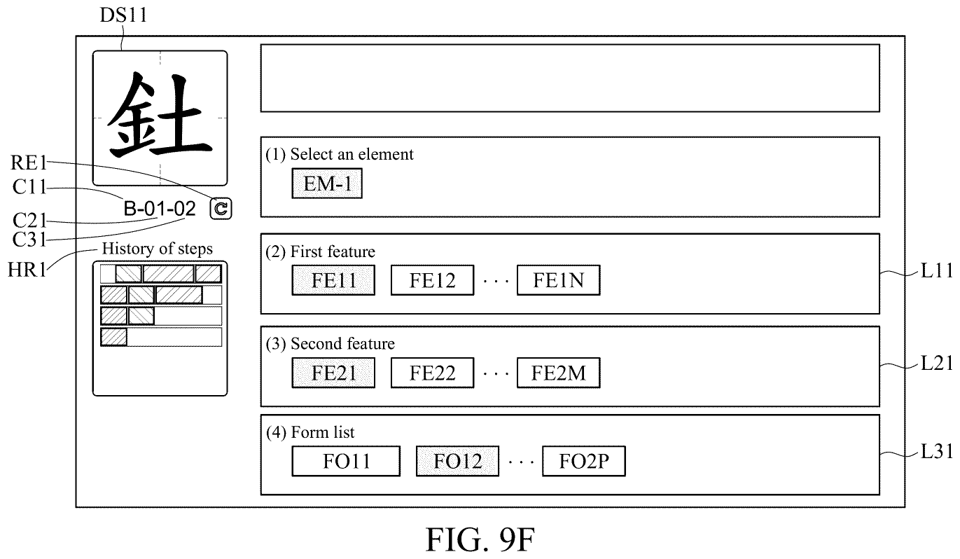

In view of above, FIG. 8 shows a method 300A of inputting a character according to some embodiments of the subject invention. FIG. 9A, FIG. 9B, FIG. 9C, FIG. 9D, FIG. 9E and FIG. 9F show user interfaces according to some embodiments of the subject invention. This embodiment provides a method of inputting an element to execute the input of the character; as shown in FIG. 3, 24 elements may be represented with numbers or English letters. For users familiar with the input method disclosed by the subject invention, the numbers or the English letters representing the element can be directly input, and thus the step of inputting an element family is omitted.

As shown in FIG. 8, in step S301, the user interface (such as a user interface 12 of an electronic device 100) receives a first command which indicates an element.

In some embodiments, the user interface shown in FIG. 9A can correspond to a display frame prior to performing step S301. The user interface in FIG. 9A displays an element table EM which includes elements EM-1, EM-2 . . . , EM-15, EM-16 . . . , EM-δ (e.g., a menu L01), and δ is a positive integer. The element table EM can include one or more of the elements shown in FIG. 3. The user interface in FIG. 9A can be configured to receive the first command to select one of the element table. The first command may include that a user clicks on one of the element table in an Element menu displayed via the user interface.

The user interface in FIG. 9A includes a display area DS11. As shown in FIG. 9A, the display area DS11 can be used for displaying selected elements, roots or forms. The user interface in FIG. 9A includes codes C11, C21 and C31 associated with the character. As shown in FIG. 9A, the code C11 is 00, the code C21 is 00 and the code C31 is 00 before the first command is received.

Step S301 can correspond to the user interface shown in FIG. 9B. The user interface in FIG. 9B can be configured to receive the first command to display the element (such as the element EM-1) associated with the first command. The user can input the first command through the user interface (such as a physical keyboard or a virtual keyboard), and the first command is associated with the displayed element. For example, if the user intends to input [symbol] (thorium)”, in step 301, an English letter “B” or a number “2” representing the element [symbol] (soil)” needs to be inputted. This paragraph contains foreign characters to illustrate the instant invention; and these foreign characters form no part of the instant invention.

As shown in FIG. 8, in step S303, a first menu is displayed, which includes a plurality of first features that classify a first group of roots associated with the element (such as the element EM-1 in FIG. 9A and FIG. 9B).

Step S303 can correspond to the user interface as shown in FIG. 9C. The user interface in FIG. 9C displays a first menu L11 which includes a plurality of first features FE11, FE12 . . . , FE1N that classify the first group of roots associated with the element (such as the element EM-1 in FIG. 9A), and N is a positive integer. The number of the plurality of first features is smaller than a first predetermined value. Each of the plurality of first features is related to the main vision of the root relative to a form. In some embodiments, the first group of roots is not displayed in the user interface. In some embodiments, each of the plurality of first features refers to a position of the root relative to the form, refers to a stroke (such as [symbol] (horizontal stroke)”, [symbol] (vertical stroke)”, [symbol] (left-falling stroke)”, “' (dot stroke)”, [symbol] (vertical-hook stroke)”, [symbol] (slant-hook stroke)”, and [symbol] (bend-hook stroke)” which can be added to the root relative to the form, refers to that whether the root is obvious or hidden relative to the form, refers to a size of the root relative to the form, or refers to a shape of the root relative to the form. Taking the element [symbol] (soil)” in FIG. 4 as an example, two first features which classify the associated first group of roots are “obvious” and “hidden in the root”, i.e., the first feature FE11 represents “obvious”, and the first feature FE12 represents “hidden in the root”. This paragraph contains foreign characters to illustrate the instant invention; and these foreign characters form no part of the instant invention.

In some embodiments, the first menu can be displayed by a display unit 12B of the electronic device 100, and the first menu moves vertically or horizontally in the display unit during the first time.

In some embodiments, the display area DS11 in FIG. 9C includes the selected element [symbol] (soil)”, the code C11 is displayed as B which is an English letter representing the element [symbol] (soil)”, and the first features displayed in the list L11 are “obvious” and “hidden in the root”. This paragraph contains foreign characters to illustrate the instant invention; and these foreign characters form no part of the instant invention.

As shown in FIG. 8, in step S305, the user interface receives a second command to select one of the plurality of first features. Step S305 can correspond to the user interface as shown in FIG. 9D. The user interface in FIG. 9D receives the second command to select the first feature FE11 of the plurality of first features; and after the first feature FE11 is selected, a processor can be configured to control the display unit 12B to change the shape of the first feature FE11, so as to remind the user. Taking the input of [symbol] (thorium)” as an example, after the element [symbol] (soil)” is selected, the selected first feature FE11 is “obvious”. This paragraph contains foreign characters to illustrate the instant invention; and these foreign characters form no part of the instant invention.

As shown in FIG. 8, in S307, a second menu is displayed, which includes a plurality of second features that classify a second group of roots in the first group of roots. Step S307 can correspond to the user interface as shown in FIG. 9D. The user interface in FIG. 9D displays a second menu L21 which includes a plurality of second features FE21, FE22 . . . , FE2M that classify the second group of roots in the first group of roots associated with the element (such as the element EM-1 in FIG. 9A), and M is a positive integer. In some embodiments, the second group of roots is not displayed in the user interface. The number of the plurality of second features is smaller than the first predetermined value. Each of the plurality of second features is associated with the main vision of the root relative to the form. In some embodiments, each of the plurality of second features refers to a position of the root relative to the form, refers to a stroke (such as [symbol] (horizontal stroke)”, [symbol] (vertical stroke)”, [symbol] (left-falling stroke)”, “' (dot stroke)”, [symbol] (vertical-hook stroke)”, [symbol] (slant-hook stroke)”, and [symbol] (bend-hook stroke)” which can be added to the root relative to the form, refers to that whether the root is obvious or hidden relative to the form, refers to a size of the root relative to the form, or refers to a shape of the root relative to the form. Taking the input of [symbol] (thorium)” as an example, after the element [symbol] (soil)” and the first feature “obvious” are selected, two second features which classify the second group of roots (i.e. roots 01 to 22 in FIG. 4) in the associated first group of roots (i.e. all roots in FIG. 4) are “on the right” and “at the bottom” relative to the form, i.e., the second feature FE21 represents “on the right”, and the second feature FE22 represents “at the bottom”. This paragraph contains foreign characters to illustrate the instant invention; and these foreign characters form no part of the instant invention.

In some embodiments, the second menu can be displayed by the display unit 12B of the electronic device 100, and the second menu moves vertically or horizontally in the display unit during the first time.

As shown in FIG. 8, in step S309, the user interface receives a third command to select one of the plurality of second features. Step S309 can correspond to the user interface as shown in FIG. 9E. The user interface in FIG. 9E receives the third command to select the second feature FE21 in the plurality of second features; and after the second feature FE21 is selected, a processor 10 can be configured to control the display unit 12B to change the graphical shape of the second feature FE21, so as to remind the user. Taking the input of [symbol] (thorium)” as an example, the selected second feature FE21 is “on the right”. This paragraph contains foreign characters to illustrate the instant invention; and these foreign characters form no part of the instant invention.

In some embodiments, the second menu may include one or more roots that cannot be classified through the second features.

In some embodiments, the display area DS11 in FIG. 9E includes the selected element [symbol] (soil)”. In some embodiments, as shown in FIG. 9E, the code C11 is B, which is associated with the element [symbol] (soil)”; and the code C21 is 01, which is associated with the root [symbol] (soil)” having the first feature of “obvious” and the second feature of “on the right” in FIG. 4. This paragraph contains foreign characters to illustrate the instant invention; and these foreign characters form no part of the instant invention.

As shown in FIG. 8, in step S311, a form list is displayed in response to at least the commands (i.e., the first command, the second command and the third command). In some embodiments, if the form list includes a plurality of forms, these forms are sorted in an element family order. With this order, the user can easily find out the forms. In some embodiments, the form list includes one or more of traditional Chinese characters and simplified Chinese characters.

Step S311 can correspond to the user interface as shown in FIG. 9E. The user interface in FIG. 9E displays a form list L31 which includes forms FO11, FO12 . . . , FO1P, and P is a positive integer. Taking the root [symbol] (soil)” in FIG. 4 as an example, the forms FO11, FO12 . . . , FO1P with the first feature FE11 and the second feature FE21 include: [symbol] (soil)”, [symbol] (thorium)”, [symbol] (vomit)”, [symbol] (du)”, [symbol] (society)”, [symbol] (male bird and beast)”, [symbol] (kitchen range)”, [symbol] (belly)”, [symbol] (thorium)”, and [symbol] (yao)”. This paragraph contains foreign characters to illustrate the instant invention; and these foreign characters form no part of the instant invention.

As shown in FIG. 8, in step S313, the user interface receives a fourth command to select one form in the form list, so as to complete the input of the character. Step S313 can correspond to the user interface as shown in FIG. 9F. The user interface in FIG. 9F receives the fourth command to select a form FO12 in the form list; and after the form FO12 is selected, the processor 10 can be configured to control the display unit 12B to change the graphical shape of the form FO12, so as to remind the user. Taking the input of [symbol] (thorium)” as an example, the user can select [symbol] (thorium)” from the forms of [symbol] (soil)”, [symbol] (thorium)”, [symbol] (vomit)”, [symbol] (du)”, [symbol] (society)”, [symbol] (male bird and beast)”, [symbol] (kitchen range)”, [symbol] (belly)”, [symbol] (thorium)”, and [symbol] (yao)”. The display area DS11 in the user interface in FIG. 9F displays the form [symbol] (thorium)”. In some embodiments, as shown in FIG. 9F, the codes C11, C21 and C31 are B-01-02, which are consistent with codes B-01-02 corresponding to the form [symbol] (thorium)” in FIG. 5. This paragraph contains foreign characters to illustrate the instant invention; and these foreign characters form no part of the instant invention.

In some embodiments, the user interface shown in FIG. 9F can be configured to receive a command to select one of a plurality of options in a “history of steps” HR1, and the plurality of options respectively correspond to one of steps S301-S313. If one of the options in the history of steps HR1 is selected, it can be returned to the corresponding step.

In some embodiments, the user interface as shown in FIG. 9F can be configured to receive a command to select a “return RE1” button, and then it can be returned to the previous step. For example, it can be returned to step S307 from step S311.

The method of inputting a character disclosed in FIG. 8 first receives a command to select an element, and then uses a plurality of first and second features that can sequentially classify a group of roots associated with the element to generate a form list associated with the root, and finally receives a command to select a form in the form list to complete the inputting of a character. The features disclosed in this application refers to a position of the root relative to the form, refers to a stroke that can be added to the root relative to the form, refers to whether the root is obvious or hidden relative to the form, refers to the size of the root relative to the form, or refers to a shape of the root relative to the form.

A recognition unit of Chinese characters is nota stroke but a part. Association and comparison are applied, and parts are used as learning points, so that it is enough to enhance reading and literacy skills, and can also reduce and avoid typos in writing. Therefore, for computer input of an online dictionary, this bottleneck/obstacle needs to be overcome. According to the objective of “simplification”, the root arrangement can be summarized into the following two logical steps: (All prompts are displayed systematically on the screen to reduce the pressure on students to memorize.) (1) First, roots are listed according to their features; and (2) the roots are arranged according to an order of element families of strokes above. If there are still too many roots, the foregoing steps can be repeated and analyzed, and multi-level classification is performed to make the method of inputting a character of the subject invention easier to operate, so that the user (such as a non-native speaker) can identify the parts, apply association and comparison, and input a character more quickly.

In some embodiments, some fonts have elongated strokes, which are purely from the physical and artistic aesthetic effects of Chinese characters evolved from seal script, official script, and regular script, can be long or short, so they are omitted and not used in the subject invention. This type of characters appears as special cases during an input process, but in fact they are the rewards of Chinese characters that the user can obtain during the input process. The following strokes are classified into [symbol] (second)”, [symbol] , and the like. When such fonts appear, these strokes can be discarded and an upper single stroke or combination can be used to determine the element and the root of the character according to the method of inputting a character described in this application. This paragraph contains foreign characters to illustrate the instant invention; and these foreign characters form no part of the instant invention.

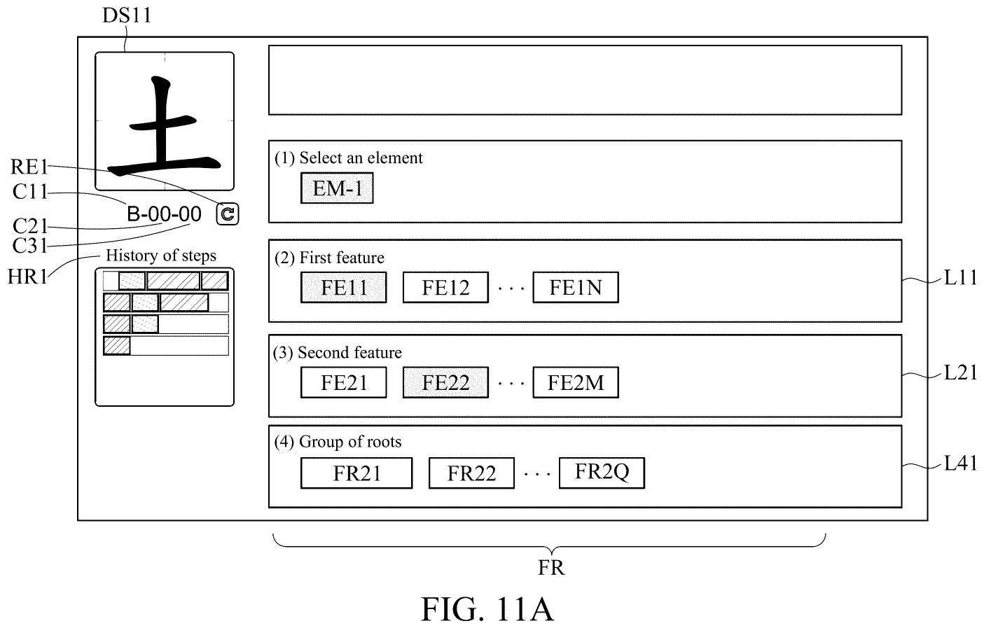

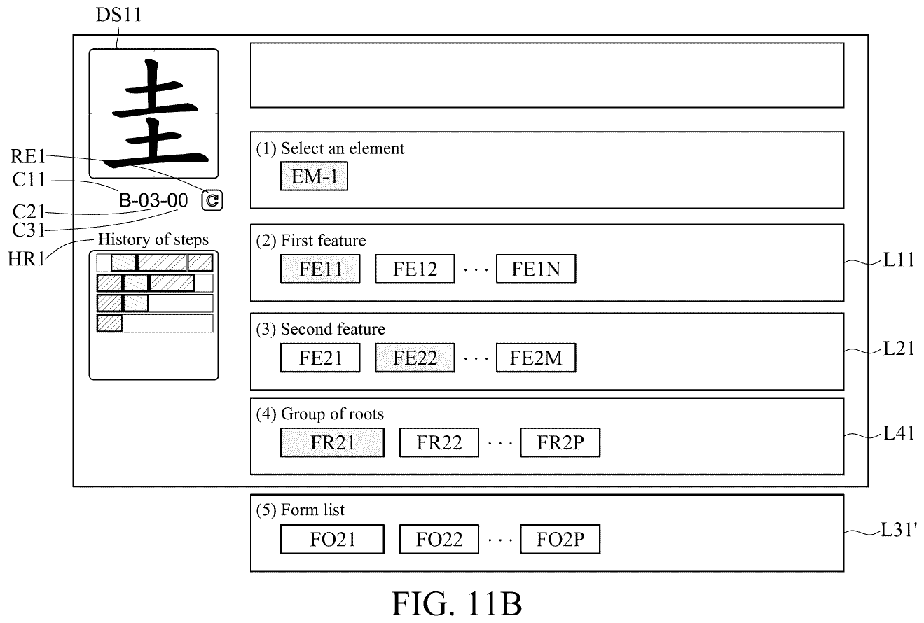

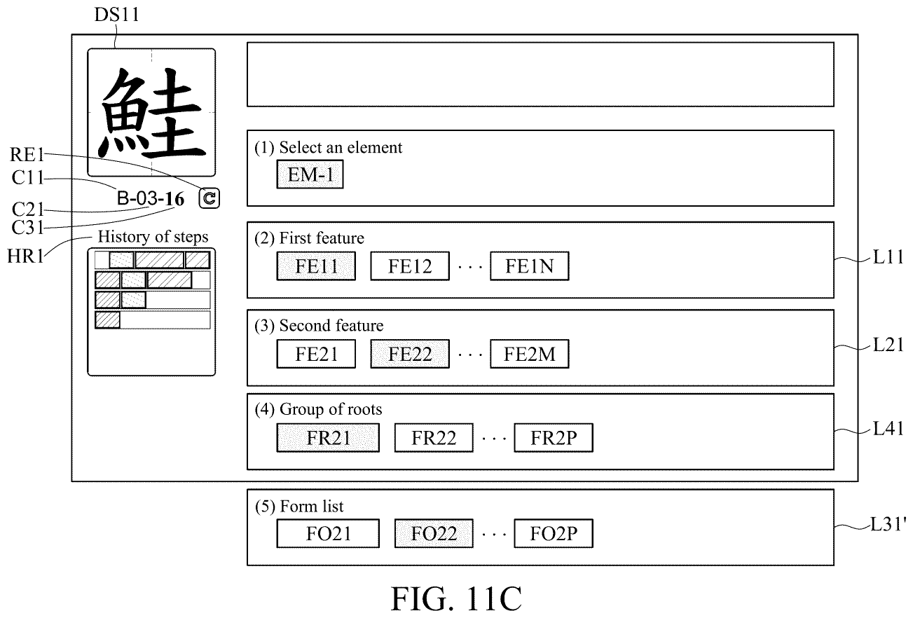

FIG. 10 is a method 300B of inputting a character according to some embodiments of the subject invention. The method 300B of inputting a character of FIG. 10 is similar to the method 300A of inputting a character of FIG. 8, and their differences will be described in detail subsequently. FIGS. 11A, 11B, and 11C area user interface according to some embodiments of the subject invention.

For steps S301, S303, S305, S307, and S309 in FIG. 10, reference may be made to the contents described in FIG. 8 and FIGS. 9A, 9B, 9C, and 9D.

As shown in FIG. 10, in step S315, a third menu is displayed, and the third menu includes a third group of roots of the second group of roots corresponding to the selected second feature. In some embodiments, the user interface 12 (i.e., the display unit 12B) of the electronic device 100 can be configured to display the third menu.

Step S315 may correspond to the user interface shown in FIG. 11B. The user interface of FIG. 11A displays a third menu L41, which includes a third group of roots (or group of roots) FR (Root table) of the second group of roots corresponding to the selected second feature, which includes roots FR21, FR22, . . . , and FR2Q, where Q is a positive integer. The number of roots FR21, FR22, . . . , and FR2Q in the third group of roots FR is less than a first predetermined value. Taking the element [symbol] (soil)” in FIG. 4 as an example, there are still too many roots with the first feature FE11 “obvious” and the second feature FE12 “at the bottom”, so the third group of roots FR can be classified by adding a stroke, for example: FR21 is added with [symbol] (horizontal stroke)”, FR22 is added with [symbol] (vertical stroke)”, FR23 is added with “' (dot stroke)”, and FR24 is added with [symbol] (bend-hook stoke)”. The third group of roots added with [symbol] (horizontal stroke)” includes: a main root [symbol] (gui)” and its subordinate root [symbol] (ya)”; a main root [symbol] and its subordinate roots [symbol] and [symbol] ; and a main root [symbol] and its subordinate roots [symbol] and [symbol] . This paragraph contains foreign characters to illustrate the instant invention; and these foreign characters form no part of the instant invention.

In an embodiment of the subject invention, the first group of roots corresponding to the selected element in step S303 may be referred to as a parent group of roots (or main group of roots). The parent group of roots includes all roots associated with the selected element. The roots of the parent group of roots may be classified according to the first features FE11, FE12, . . . , and FE1N. The parent group of roots is not displayed in the user interface. The second group of roots in step S305 may be referred to as a sub-group of roots (or subordinate group of roots), which includes all roots associated with the selected element and the selected first feature. The roots of the sub-group of roots may be classified according to the second features FE21, FE22, . . . , and FE2M. The sub-group of roots (i.e., the second group of roots) may be hidden, i.e., it may not be displayed in the user interface. The third group of roots FR in step S315 may be referred to as a sub-group of roots, which includes all roots associated with the selected element and the selected first and second features. The sub-group of roots FR may be appearing and may be displayed in the user interface because the number of the roots meets a specific condition (for example, less than the first predetermined value). The parent group of roots and the sub-group of roots (or the main group of roots and the subordinate group of roots) in the subject invention are in a relative relationship. Therefore, relative to the sub-group of roots FR, the second group of roots may be referred to as the parent group of roots. Relative to the first group of roots, the second group of roots may be referred to as the sub-group of roots.

As shown in FIG. 10, in step S317, a fifth command is received through the user interface to select one of the third groups of roots. In some embodiments, the user interface 12 (i.e., the input unit 12A) of the electronic device 100 can be configured to receive the fifth command to select one of the third groups of roots.

Step S317 may correspond to the user interface shown in FIG. 11B. The user interface of FIG. 11B receives the fifth command to select FR21 of the third group of roots FR. In some embodiments, a display area DS11 of FIG. 11B includes the selected root [symbol] (gui)”. In some embodiments, as shown in FIG. 11B, the code C11 is B, which is associated with the element [symbol] (soil)”; and the code C21 is 03, which is associated with the root [symbol] (gui)”. This paragraph contains foreign characters to illustrate the instant invention; and these foreign characters form no part of the instant invention.

As shown in FIG. 10, in step S311, the form list is displayed in response to at least these commands (i.e., the first command, the second command, the third command, and the fifth command).

Step S311 may correspond to the user interface shown in FIG. 11B. The user interface of FIG. 11B displays the form list L31′, which includes fonts FO21, FO22, . . . , and FO2P, where P is a positive integer. The form list L31′ is associated with one of the selected third groups of roots. Taking the root [symbol] (gui)” in FIG. 4 as an example, the associated forms FO21, FO22, . . . , and FO1P include [symbol] (gui)”, [symbol] (salmon)”, [symbol] (quartz)”, [symbol] (kui)”, [symbol] (wa)”, [symbol] (gua)”, [symbol] (plot)”, . . . , and [symbol] (wa)”. This paragraph contains foreign characters to illustrate the instant invention; and these foreign characters form no part of the instant invention.

As shown in FIG. 10, in step S313, the user interface receives a fourth command to select a form in the form list to complete an input of a character. Step S313 of FIG. 10 may correspond to the user interface shown in FIG. 11C. A fourth command is received through the user interface of FIG. 11C to select one form FO22 in the form list, where after the form FO22 is selected, the processor 10 can be configured to control the display unit 12B to change the appearance of the form FO22 to remind the user. Taking the root [symbol] (gui)” in FIG. 4 as an example, the selected form FO22 is [symbol] (salmon)”. A display area DS11 in the user interface of FIG. 11C displays the form [symbol] (salmon)”. In some embodiments, as shown in FIG. 11C, the codes C11, C21, and C31 are B-03-16, which are associated with the form [symbol] (salmon)”. This paragraph contains foreign characters to illustrate the instant invention; and these foreign characters form no part of the instant invention.

The method of inputting a character disclosed in FIG. 10 first receives a command to select an element, and then uses a plurality of first and second features that can sequentially classify a group of roots associated with the element to generate a group of roots associated with one of the plurality of first features and one of the plurality of second features; and then receives a command to select one of the groups of roots to display a form list associated with the selected root, and finally receives a command to select one form of the form list to complete the inputting of a character.

Since the number of roots of the sub-group of roots (for example, the second group of roots) of the group of roots (for example, the first group of roots) classified according to the plurality of first features is greater than the predetermined value, the subject invention discloses to perform next-level classification on the second group of roots in the first group of roots, so that the number of roots of the third group of roots in the second group of roots is less than the predetermined value. For computer input of an online dictionary, according to the objective of “simplification”, multi-level classification is performed on the roots. For example, the roots are arranged according to root features or an order of element families with added strokes. If there are still too many roots in the group of roots (for example, the first group of roots or the second group of roots), multi-level classification may be performed to make the method of inputting a character of the subject invention easier to operate, so that the user (such as a non-native speaker) can identify the parts, apply association and comparison, and input a character more quickly.

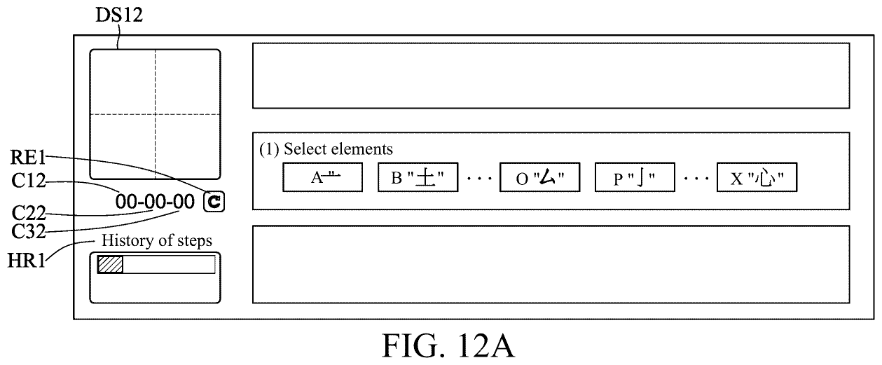

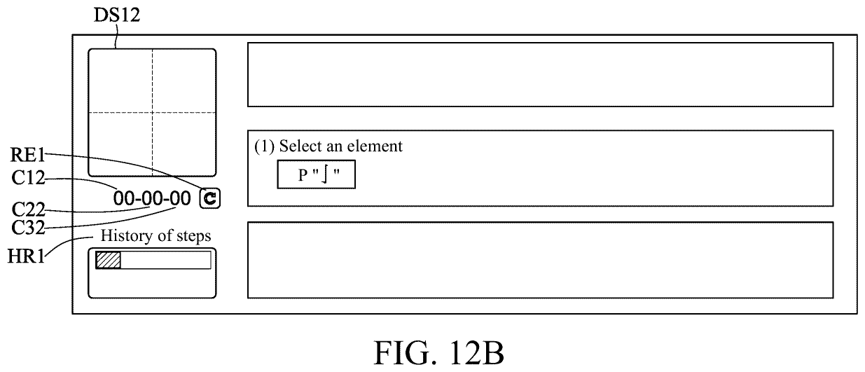

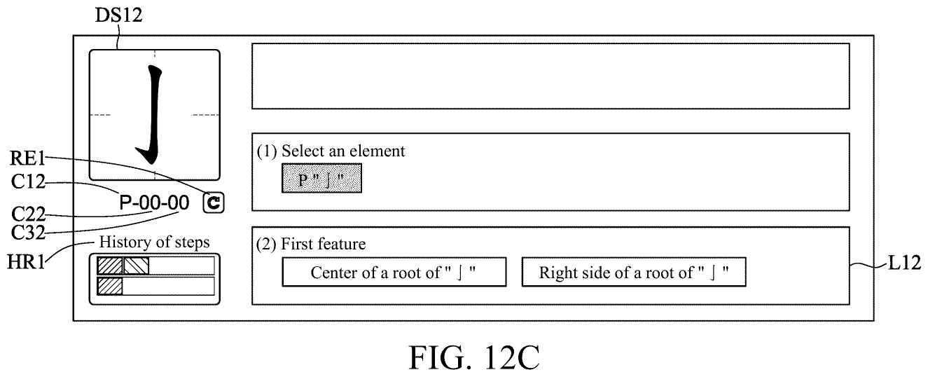

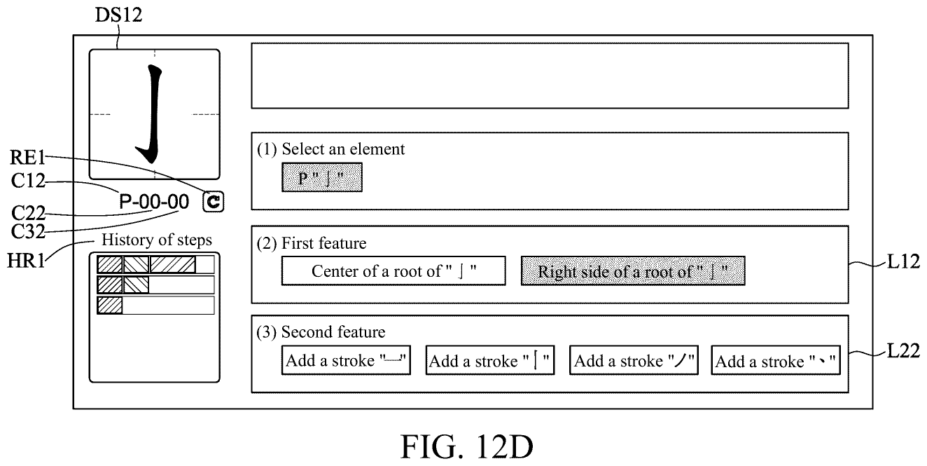

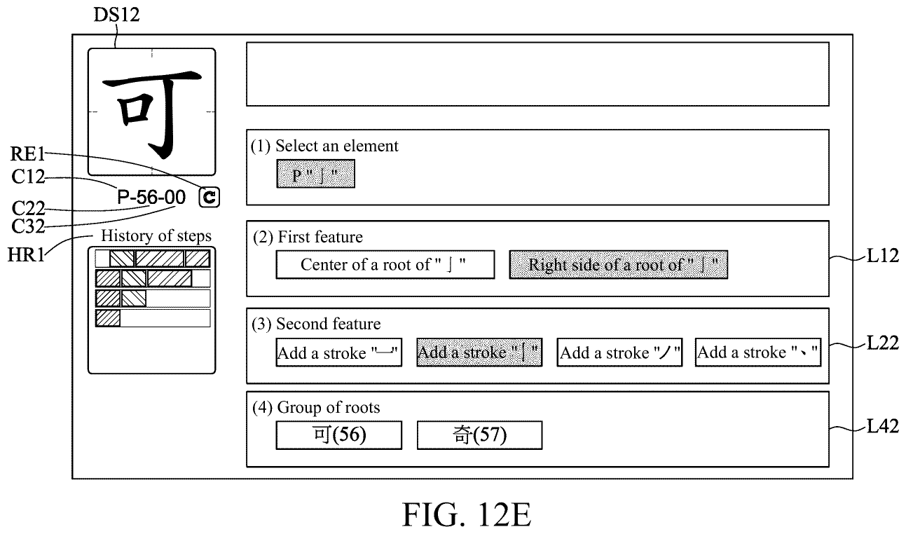

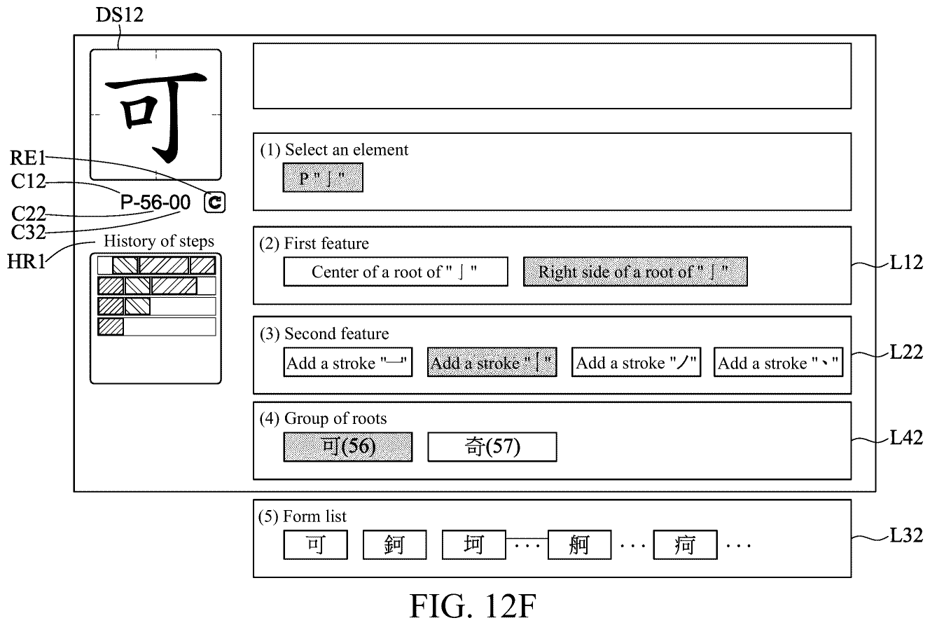

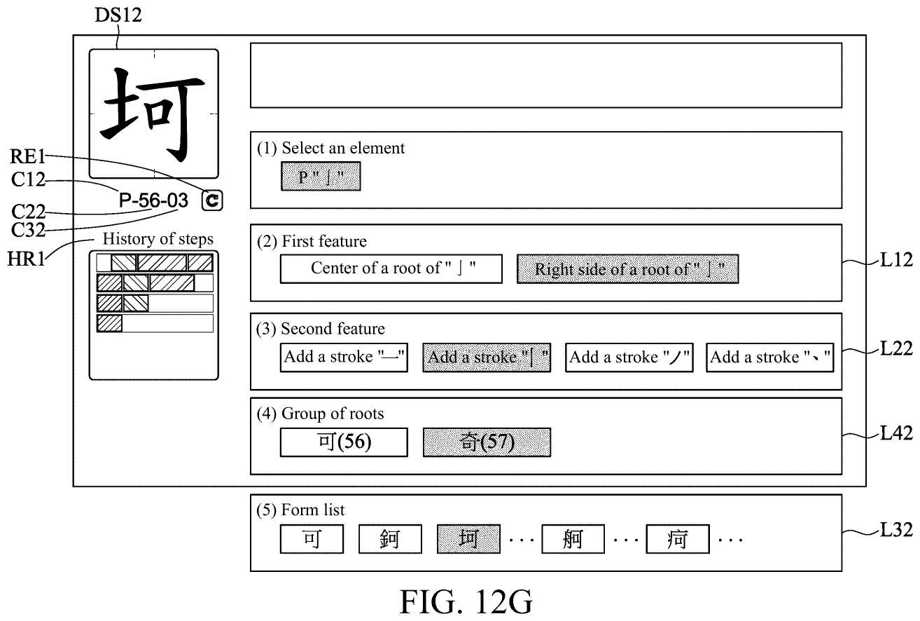

FIGS. 12A, 12B, 12C, 12D, 12E, and 12F are a user interface according to some embodiments of the subject invention. The user interface in FIGS. 12A, 12B, 12C, 12D, 12E, and 12F describes a process of inputting a form [symbol] (rough)” (corresponding form number: P-56-03) through the method of inputting a character in FIG. 10. This paragraph contains foreign characters to illustrate the instant invention; and these foreign characters form no part of the instant invention.

Corresponding to step S301 of the method 300B of inputting a character, the user interface of FIG. 12A displays an element table, which includes the element [symbol] (horizontal stroke)” (element code: A), the element [symbol] (soil)” (element code: B), . . . , the element [symbol] (element code: O), the element [symbol] (vertical-hook stroke)” (element code: P), . . . , and the element [symbol] (xin)” (element code: X). The user interface of FIG. 12A includes a display area DS21. As shown in FIG. 12A, a display area DS12 does not yet include the form. The user interface of FIG. 12A includes codes C12, C22, and C32 related to the character. As shown in FIG. 12A, the code C12 is 00, the code C22 is 00, and the code C32 is 00. This paragraph contains foreign characters to illustrate the instant invention; and these foreign characters form no part of the instant invention.

Corresponding to step S301 of the method 300B of inputting a character, the user interface of FIG. 12B can be configured to receive a first command to display an element associated with the first command (for example, the element [symbol] (vertical-hook stoke)”). This paragraph contains foreign characters to illustrate the instant invention; and these foreign characters form no part of the instant invention.

Corresponding to step S303 of the method 300B of inputting a character, the user interface of FIG. 12C displays a first menu L12, which includes a plurality of first features “in the middle of a root of [symbol] (vertical-hook stroke)” and “on the right side of a root of [symbol] (vertical-hook stroke)” that can classify a first group of roots associated with the element [symbol] (vertical-hook stoke)”. In some embodiments, the display area DS11 of FIG. 9C includes the selected element [symbol] (vertical-hook stoke)”. In some embodiments, as shown in FIG. 9C, the code C12 is P, which is associated with the element [symbol] (vertical-hook stoke)”. This paragraph contains foreign characters to illustrate the instant invention; and these foreign characters form no part of the instant invention.

Corresponding to step S305 of the method 300B of inputting a character, a second command is received through the user interface of FIG. 12D to select the first feature “on the right side of a root of [symbol] (vertical-hook stroke)” of the plurality of first features. After the first feature “on the right side of a root of [symbol] (vertical-hook stroke)” is selected, the processor can be configured to control the display unit 12B to change the appearance of the first feature “on the right side of a root of [symbol] (vertical-hook stroke)” to remind the user. This paragraph contains foreign characters to illustrate the instant invention; and these foreign characters form no part of the instant invention.

Corresponding to step S307 of the method 300B of inputting a character, the user interface of FIG. 12D displays a second menu L22, which includes a plurality of second features “adding [symbol] (horizontal stroke)”, “adding [symbol] (vertical stroke)”, “adding [symbol] (left-falling stroke)”, and “adding ' (dot stroke)” that can classify the second group of roots in the first group of roots associated with the element [symbol] (vertical-hook stoke)”. This paragraph contains foreign characters to illustrate the instant invention; and these foreign characters form no part of the instant invention.

Step S309 may correspond to the user interface shown in FIG. 12E. A third command is received through the user interface of FIG. 12E to select the second feature “adding [symbol] (vertical stroke)” of the plurality of second features. After the second feature “adding [symbol] (vertical stroke)” is selected, the processor 10 can be configured to control the display unit 12B to change the appearance of the second feature “adding [symbol] (vertical stroke)” to remind the user. This paragraph contains foreign characters to illustrate the instant invention; and these foreign characters form no part of the instant invention.

Step S315 may correspond to the user interface shown in FIG. 12E. The user interface of FIG. 12E displays a third menu L42, which includes the third group of roots of the second group of roots corresponding to the selected second feature (i.e., “adding [symbol] (vertical stoke)”), and the third group of roots includes a main root [symbol] (ke)” (root code: 56) and a subordinate root [symbol] (strange)” (root code: 57). This paragraph contains foreign characters to illustrate the instant invention; and these foreign characters form no part of the instant invention.

Step S317 may correspond to the user interface shown in FIG. 12F. The user interface of FIG. 12E receives a fifth command to select one of the third groups of roots, for example, [symbol] (ke)”. The fifth command may input the root code 56 of [symbol] (ke)” through the user interface 12 of the electronic device 100 or through a cursor click. This paragraph contains foreign characters to illustrate the instant invention; and these foreign characters form no part of the instant invention.

In some embodiments, the display area DS12 of FIG. 12F includes the selected root [symbol] (ke)”. In some embodiments, as shown in FIG. 12F, the code C12 is P, which is associated with the element [symbol] (vertical-hook stoke)”; and the code C22 is 56, which is associated with the root [symbol] (ke)”. This paragraph contains foreign characters to illustrate the instant invention; and these foreign characters form no part of the instant invention.

Step S311 may correspond to the user interface shown in FIG. 12F. The user interface of FIG. 12F displays the form list L32, which includes fronts [symbol] (ke)”, [symbol] (columbium)”, [symbol] (rough)”, . . . , [symbol] (ge)”, and [symbol] (ke)”. This paragraph contains foreign characters to illustrate the instant invention; and these foreign characters form no part of the instant invention.

Step S313 of FIG. 10 may correspond to the user interface shown in FIG. 12G. A fourth command is received through the user interface of FIG. 11C to select one form [symbol] (rough)” in the form list. After the form [symbol] (rough)” is selected, the processor 10 can be configured to control the display unit 12B to change the appearance of the form [symbol] (rough)” to alert the user. The display area DS12 in the user interface of FIG. 12G displays the form [symbol] (rough)”. In some embodiments, as shown in FIG. 12G, the codes C11, C21, and C31 are P-56-03, which correspond to the form [symbol] (rough)”. This paragraph contains foreign characters to illustrate the instant invention; and these foreign characters form no part of the instant invention.

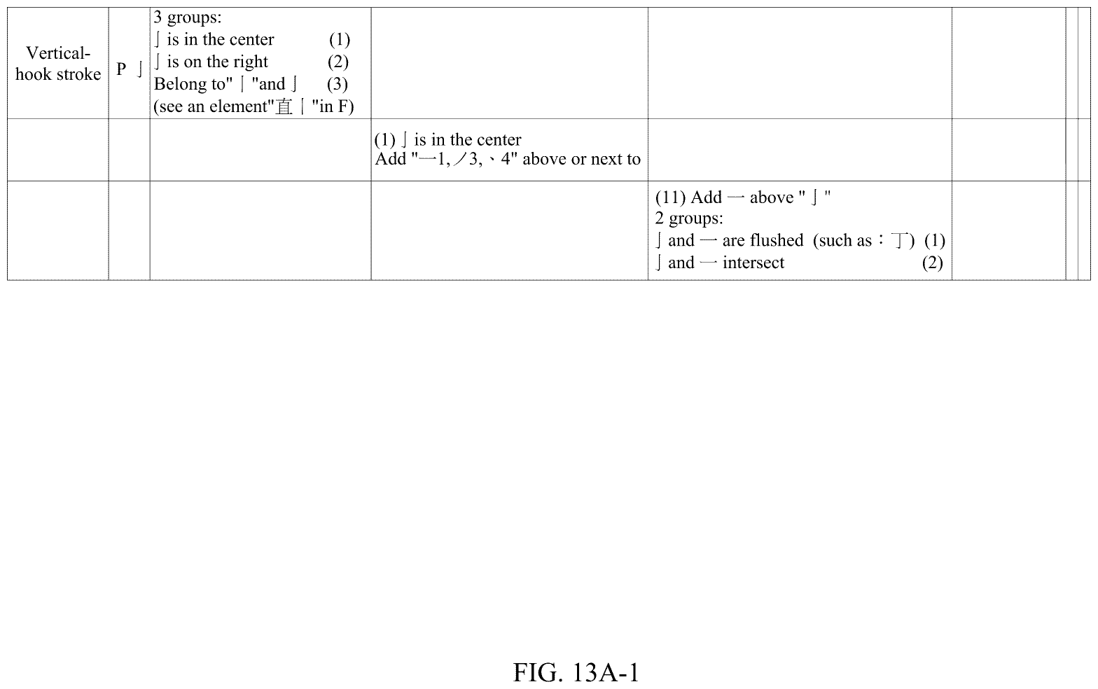

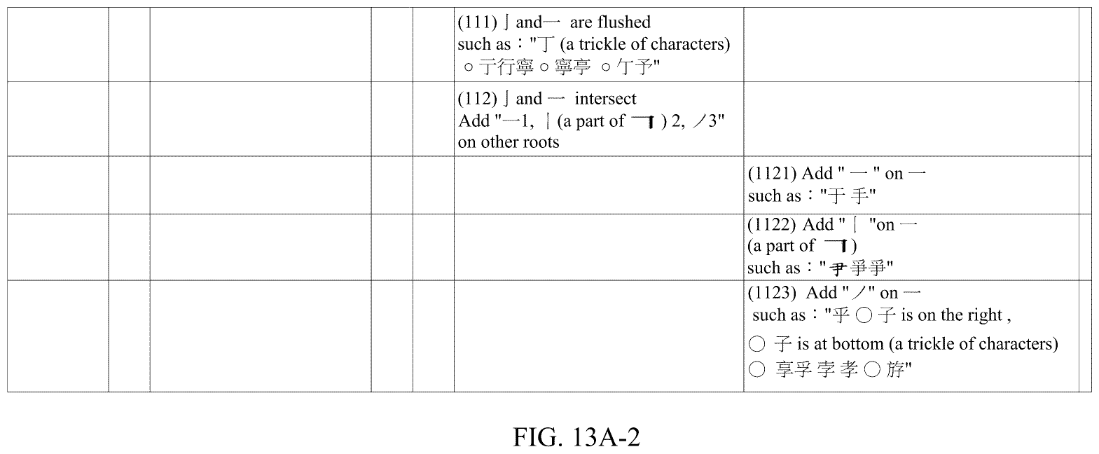

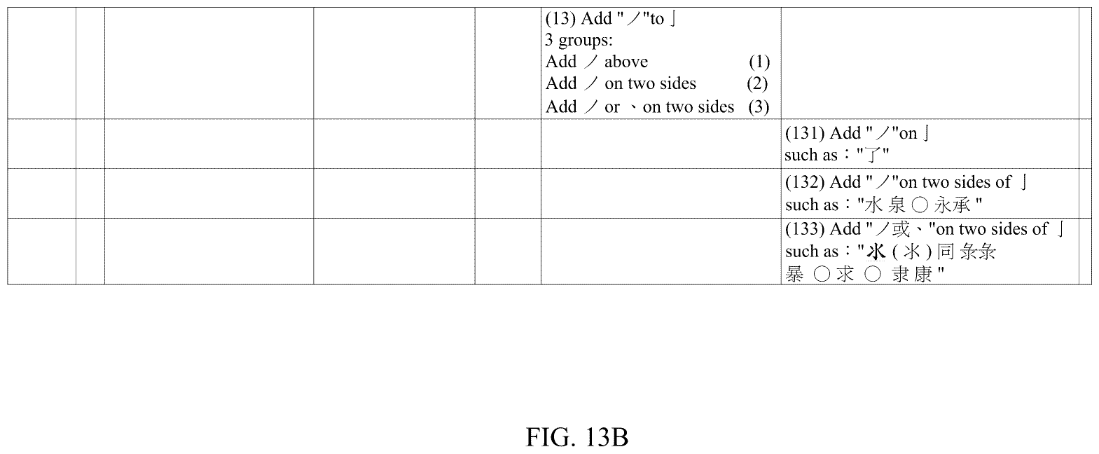

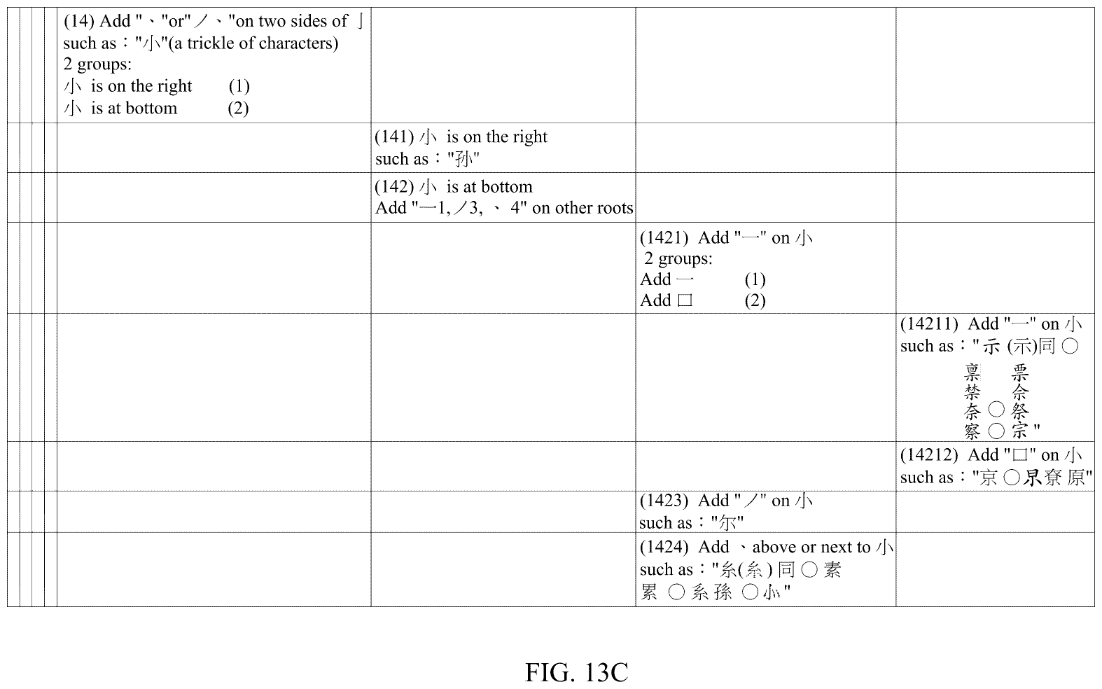

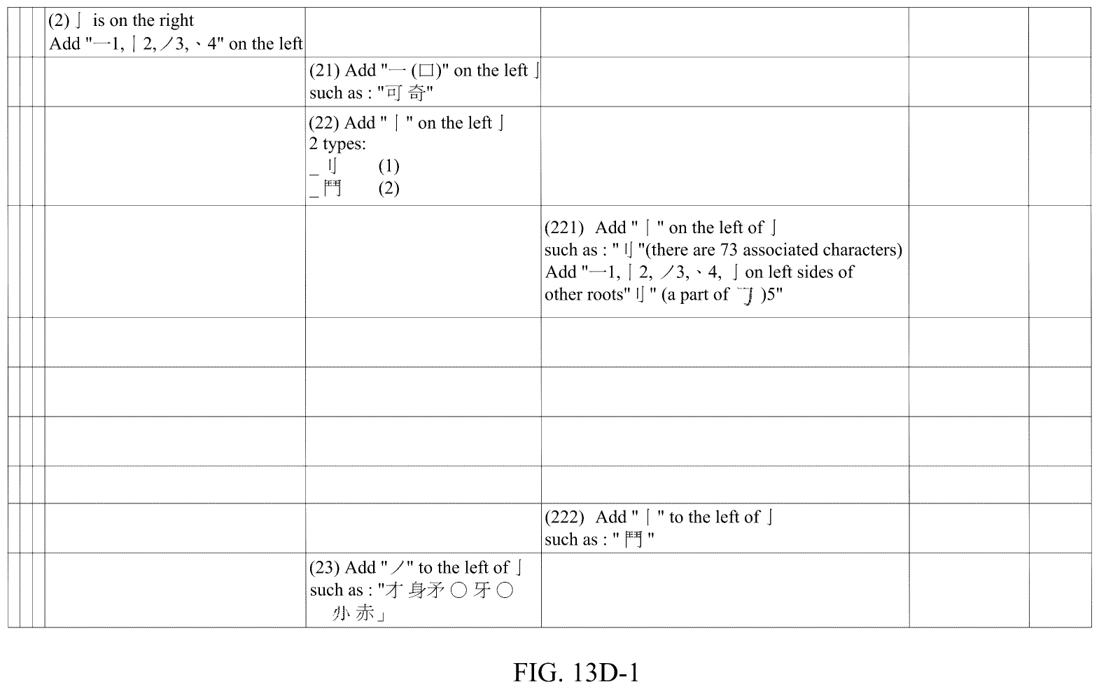

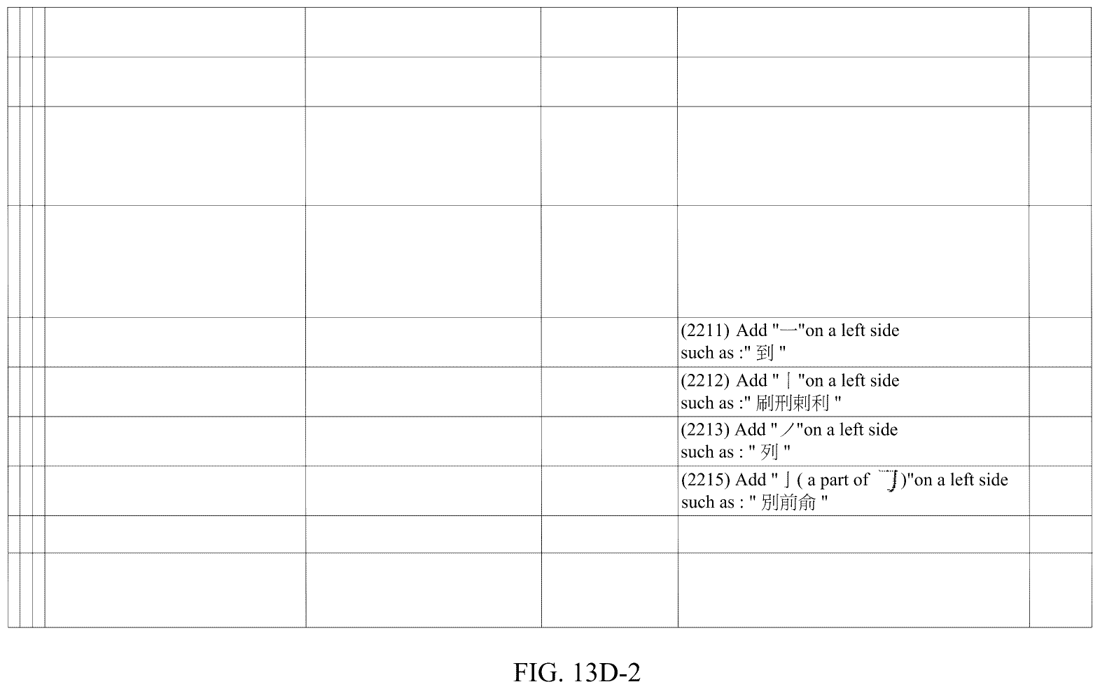

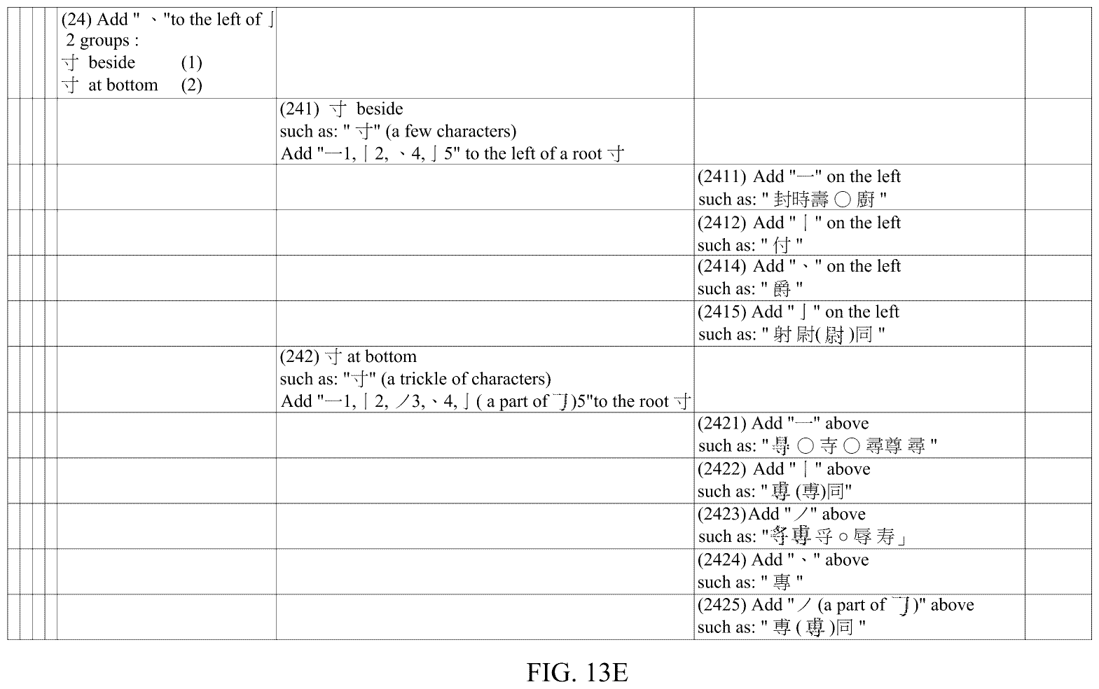

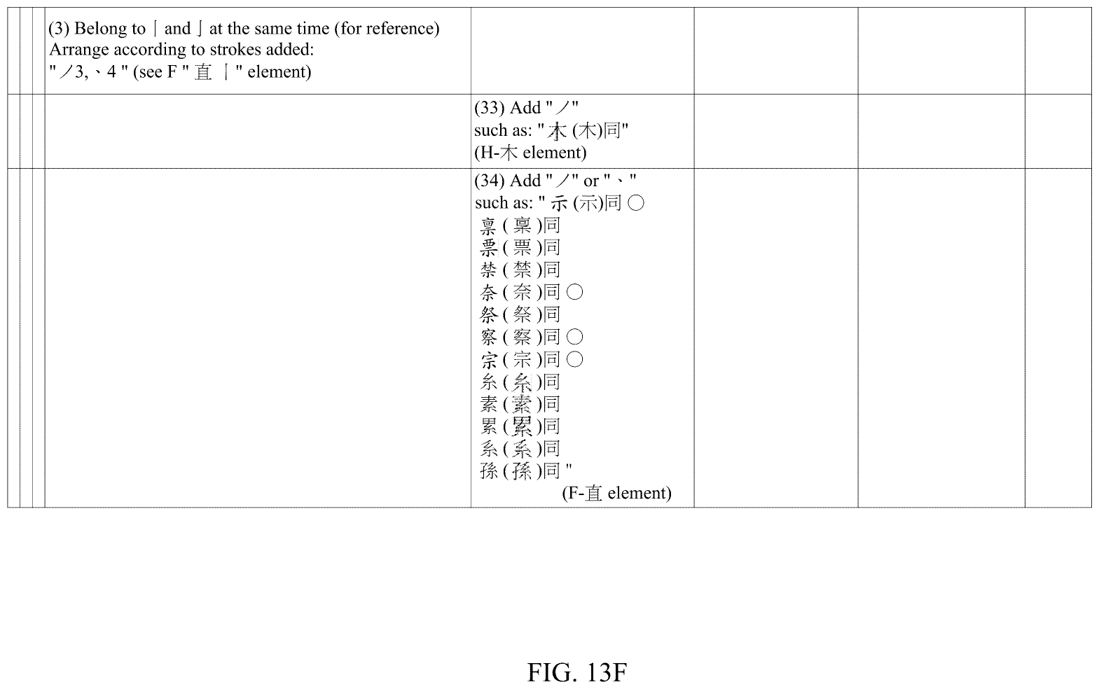

FIGS. 13A-1, 13A-2, 13B, 13C, 13D-1, 13D-2, 13E, and 13F are a root table according to some embodiments of the subject invention. FIGS. 13A-1, 13A-2, 13B, 13C, 13D-1, 13D-2, 13E, and 13F are root tables associated with the element [symbol] (vertical-hook stoke)”. FIG. 13 shows from left to right how to classify roots to which the element [symbol] (vertical-hook stroke)” belongs. Referring to FIG. 1, the memory 11A or the memory 11B can be configured to store data converted from the root tables of FIGS. 13A-1, 13A-2, 13B, 13C, 13D-1, 13D-2, 13E, and 13F. The processor 10 can be configured to execute a computer program stored in the memory 11A to extract some or all of the data converted from the root tables of FIG. 13. The root tables in FIGS. 13A-1, 13A-2, 13B, 13C, 13D-1, 13D-2, 13E, and 13F are arranged in ascending order, which facilitates the processor 10 to extract some or all of the root data in the root tables by executing the computer program. This paragraph contains foreign characters to illustrate the instant invention; and these foreign characters form no part of the instant invention.

FIG. 14 is a method 400A of inputting a character according to some embodiments of the subject invention. The method 400A of inputting a character of FIG. 14 is similar to the method 300A of inputting a character of FIG. 8, and their differences will be described in detail subsequently.

The method 400A of inputting a character further includes steps S401 and S403. Step S401 may follow step S305. Step S403 may follow step S401. Step S307 follows step S403.

As shown in FIG. 14, in step S401, a fourth menu is displayed before the second menu is displayed, and the fourth menu includes a plurality of third features that can classify the third group of roots in the first group of roots. In some embodiments, each of the plurality of third features refers to a position of the root relative to the form, refers to a stroke that can be added to the root relative to the form (for example, [symbol] (horizontal stroke)”, [symbol] (vertical stroke)”, [symbol] (left-falling stroke)”, “' (dot stroke)”, [symbol] (vertical-hook stroke)”, [symbol] (slant-hook stroke)”, and [symbol] (bend-hook stroke)”), refers to whether the root is obvious or hidden relative to the form, refers to the size of the root relative to the form, or refers to a shape of the root relative to the form. This paragraph contains foreign characters to illustrate the instant invention; and these foreign characters form no part of the instant invention.

As shown in FIG. 14, in step S403, a sixth command is received through the user interface to select one of the plurality of third features. The user may input the sixth command through the user interface (for example, a physical keyboard or a virtual keyboard), which is associated with one of the third features. In some embodiments, the second group of roots may be included in the third group of roots. The first group of roots is classified into more levels through level classification, so that the number of roots in the group of roots can be reduced, and the user can quickly identify the required root in the user interface and make the method 400A of inputting a character is faster, and can save the memory used by the electronic device and the system that perform the method of inputting a character, making inputting of a character faster.

FIG. 15 is a method 400B of inputting a character according to some embodiments of the subject invention. The method 400B of inputting a character of FIG. 15 is similar to the method 400A of inputting a character of FIG. 14, and their differences will be described in detail subsequently.

The method 400B of inputting a character further includes steps S405 and S407. Step S405 may follow step S305. Step S407 may follow step S405. Step S401 may follow step S407.

As shown in FIG. 15, in step S405, a fifth menu is displayed before the fourth menu is displayed, and the fifth menu includes a plurality of fourth features that can classify the fourth group of roots in the first group of roots. In some embodiments, each of the plurality of fourth features refers to a position of the root relative to the form, refers to a stroke that can be added to the root relative to the form (for example, [symbol] (horizontal stroke)”, [symbol] (vertical stroke)”, [symbol] (left-falling stroke)”, “' (dot stroke)”, [symbol] (vertical-hook stroke)”, [symbol] (slant-hook stroke)”, and [symbol] (bend-hook stroke)”), refers to whether the root is obvious or hidden relative to the form, refers to the size of the root relative to the form, or refers to a shape of the root relative to the form. This paragraph contains foreign characters to illustrate the instant invention; and these foreign characters form no part of the instant invention.

As shown in FIG. 15, in step S407, a seventh command is received through the user interface to select one of the plurality of fourth features. The user may input the seventh command through the user interface (for example, a physical keyboard or a virtual keyboard), which is associated with one of the fourth features. Therefore, the third group of roots may be included in the fourth group of roots. The first group of roots is classified into more levels through level classification, so that the number of roots can be reduced, and the user can quickly identify the required root in the user interface and make the method 400B of inputting a character is faster, and can save memory capacity used by the electronic device and the system that perform the method of inputting a character, making inputting of a character faster. FIG. 16 is a method 500 of inputting a character according to some embodiments of the subject invention. The method 500 of inputting a character of FIG. 15 is similar to the method 300A of inputting a character of FIG. 8, and their differences will be described in detail subsequently.

The method 500 of inputting a character further includes steps S501 and S503. Step S503 may follow step S501. Step S301 may follow step S503.

As shown in FIG. 16, in step S501, the user interface receives an eighth command, which indicates an element family. In some embodiments, the element family includes [symbol] (horizontal stroke)”, [symbol] (vertical stroke)”, [symbol] (left-falling stroke)”, “' (dot stroke)”, [symbol] (vertical-hook stroke)”, [symbol] (slant-hook stroke)”, and [symbol] (bend-hook stroke)”. Each element family includes an associated element thereof (as shown in FIG. 3). The element family is one stroke and the element does not exceed four strokes. This paragraph contains foreign characters to illustrate the instant invention; and these foreign characters form no part of the instant invention.

As shown in FIG. 16, in step S503, an eighth menu is displayed, which includes an element table associated with the element family, where the element table includes the element indicated by the first command In some embodiments, when the element family in step S503 is [symbol] (horizontal stroke)”, the eighth menu includes an element table associated with the element family [symbol] (horizontal stroke)”: [symbol] (horizontal stroke)” (number: 1/code: A/pronunciation: heng); [symbol] (soil)” (number: 2/code: B/pronunciation: tu); [symbol] , and [symbol] (number: 3/code: C/pronunciation: que^{raising tone}); [symbol] (mouth)” (number: 4/code: D/pronunciation: kou); and [symbol] (sun)” (number: 5/code: E/pronunciation: ri). This paragraph contains foreign characters to illustrate the instant invention; and these foreign characters form no part of the instant invention.

Compared with the previous embodiments, the method of inputting a character of FIG. 16 further includes: selecting an element family Since the number of element families is less than the number of elements and is easy to identify, it is helpful for the users (such as a beginner) to gradually input commands to the electronic device 100 of FIG. 1 or the system 200 of FIG. 2 by identifying the element families, to input a desired character.

FIG. 17 is a method 600 of inputting a character according to some embodiments of the subject invention. The method 600 of inputting a character of FIG. 17 is similar to the method 500 of inputting a character of FIG. 16, except that the method 600 of inputting a character further includes steps S401, S403, S405 and S407 in the method 400B of inputting a character of FIG. 15. The method 600 of inputting a character combines the advantages of the method 500 of inputting a character and the method 400B of inputting a character, for example: it is helpful for the beginner to learn and the number of roots in the group of roots is reduced, which can make inputting of a character faster and save the memory capacity used by the electronic device and the system that perform the method of inputting a character, making the inputting of a character faster.

FIG. 18 is a method 700A of indexing a character according to some embodiments of the subject invention.

As shown in FIG. 18, in step S701, a character is received through a user interface. The character may be traditional Chinese, simplified Chinese, Japanese, Korean, Egyptian, English, or the like. In some embodiments, the user interface 12 of the electronic device 100 is configured to receive the character.

As shown in FIG. 18, in step S703, a processor determines a lower or right element of the character to generate a first code. In some embodiments, the processor 10 of the electronic device 100 is configured to determine the lower or right element of the character to generate the first code. For example, the lower or right element of the Chinese character [symbol] (thorium)” in FIG. 5 is [symbol] (soil)” (element code: B), and the first code may be element code: B. This paragraph contains foreign characters to illustrate the instant invention; and these foreign characters form no part of the instant invention.

As shown in FIG. 18, in step S705, the processor determines a plurality of first features that can classify the first group of roots associated with the element. In some embodiments, the number of first features is less than a first predetermined value. Each of the plurality of first features is associated with a main vision of the root relative to the form. In some embodiments, each of the plurality of first features refers to a position of the root relative to the form, refers to a stroke that can be added to the root relative to the form (for example, [symbol] (horizontal stroke)”, [symbol] (vertical stroke)”, [symbol] (left-falling stroke)”, “' (dot stroke)”, [symbol] (vertical-hook stroke)”, [symbol] (slant-hook stroke)”, and [symbol] (bend-hook stroke)”), refers to whether the root is obvious or hidden relative to the form, refers to the size of the root relative to the form, or refers to a shape of the root relative to the form. Taking the element [symbol] (soil)” in FIG. 4 as an example, the plurality of first features that classify an associated first group of roots are “obvious” and “hidden in the root”. This paragraph contains foreign characters to illustrate the instant invention; and these foreign characters form no part of the instant invention.

As shown in FIG. 18, in step S707, the processor determines one of a plurality of first features corresponding to the character. In some embodiments, the processor 10 of the electronic device 100 can be configured to determine one of a plurality of first features corresponding to the character. Taking the element [symbol] (soil)” in FIG. 4 as an example, the first feature corresponding to the character [symbol] (thorium)” is “obvious”. This paragraph contains foreign characters to illustrate the instant invention; and these foreign characters form no part of the instant invention.

As shown in FIG. 18, in step S709, the processor determines a plurality of second features that classify a second group of roots in a first group of roots, where the plurality of first features are different from the plurality of second features, and the second group of roots is associated with the element. In some embodiments, the processor 10 of the electronic device 100 can be configured to determine a plurality of second features that classify a second group of roots in the first group of roots. In some embodiments, a plurality of second features that can classify the second group of roots associated with the element [symbol] (soil)” are “on the right” and “at the bottom” of “a corresponding position of an element relative to a form”. This paragraph contains foreign characters to illustrate the instant invention; and these foreign characters form no part of the instant invention.

As shown in FIG. 18, in step S711, the processor determines one of a plurality of second features corresponding to the character. In some embodiments, the processor 10 of the electronic device 100 can be configured to determine one of a plurality of second features corresponding to the character. Taking the element [symbol] (soil)” in FIG. 4 as an example, the second feature corresponding to the character [symbol] (thorium)” is “a root is on the right of a form”. This paragraph contains foreign characters to illustrate the instant invention; and these foreign characters form no part of the instant invention.

As shown in FIG. 18, in step S713, the processor determines the root in the second group of roots according to the corresponding first feature and the corresponding second feature, and the root has a second code. In some embodiments, the processor 10 of the electronic device 100 can be configured to determine the root in the second group of roots according to the corresponding first feature and the corresponding second feature, and the root has a second code. Taking the element [symbol] (soil)” in FIG. 4 as an example, the root with first features “obvious” and “on the right” corresponding to the character [symbol] (thorium)” is [symbol] (soil)”, and the root [symbol] (soil)” has a root code “01”. The root code “01” may be the second code. Taking the element [symbol] (soil)” in FIG. 4 as an example, the root with first features “obvious” and “on the right” corresponding to the character [symbol] (thorium)” is [symbol] (soil)”, and the root [symbol] (soil)” has a root code “01”. The root code “01” may be the second code. This paragraph contains foreign characters to illustrate the instant invention; and these foreign characters form no part of the instant invention.

As shown in FIG. 18, in step S715, each of a form list of the root and the character are compared to generate a third code. In some embodiments, the processor 10 of the electronic device 100 can be configured to compare each of a form list of the root and the character to generate a third code. In some embodiments, after the character [symbol] (thorium)” is compared with the form list of the root [symbol] (soil)”: [symbol] (soil)”, [symbol] (vomit)”, [symbol] (du)”, [symbol] (society)”, [symbol] (kitchen range)”, [symbol] (belly)”, [symbol] (thorium)”, and [symbol] (yao)” (as shown in FIG. 5), a third code may be generated, which is the code “02” in the form list. The code “02” may be the third code. That is, the input character/form [symbol] (thorium)” has the code B-01-02. This paragraph contains foreign characters to illustrate the instant invention; and these foreign characters form no part of the instant invention.

The method 700A of indexing a character of FIG. 18 can accurately classify the input character through multi-level classification to obtain the first code, the second code, and the third code corresponding to the character. The electronic device 100 or the system 200 in this application can use multi-level classification to enable the processor 10 or the processing module 22 to save the memory capacity, index the correct character more quickly, and provide the corresponding code, so that the user further uses this code to search for dictionaries associated with the method of indexing a character disclosed in this application, such as CJ Chinese-English Dictionary.

FIG. 19 is a method 700B of indexing a character according to some embodiments of the subject invention. The method 700B of indexing a character of FIG. 19 is similar to the method 700A of indexing a character of FIG. 18, and their differences will be described in detail subsequently.

The method 700B of indexing a character further includes steps S717 and S719. Step S717 may follow step S707. Step S719 may follow step S717. Step S709 may follow step S719.

As shown in FIG. 19, in step S717, the processor determines a plurality of third features that can classify a third group of roots in the first group of roots, where the plurality of first features, second features, and third features are different from each other. In some embodiments, the number of the plurality of third features is less than a first predetermined value. Each of the plurality of third features is associated with a main vision of the root relative to the form. In some embodiments, each of the plurality of third features refers to a position of the root relative to the form, refers to a stroke that can be added to the root relative to the form (for example, [symbol] (horizontal stroke)”, [symbol] (vertical stroke)”, [symbol] (left-falling stroke)”, “' (dot stroke)”, [symbol] (vertical-hook stroke)”, [symbol] (slant-hook stroke)”, and [symbol] (bend-hook stroke)”), refers to whether the root is obvious or hidden relative to the form, refers to the size of the root relative to the form, or refers to a shape of the root relative to the form. This paragraph contains foreign characters to illustrate the instant invention; and these foreign characters form no part of the instant invention.

As shown in FIG. 18, in step S719, the processor determines one of a plurality of third features corresponding to the character. In some embodiments, the processor 10 of the electronic device 100 can be configured to determine one of a plurality of third features corresponding to the character.

The method 700B of indexing a character of FIG. 19 classifies the input character into three levels, so that the electronic device and the system that perform the method of indexing a character can save memory space and make indexing of a character faster.

Still referring to FIG. 2, the storage module 24 may store the program code 24C including one or more commands The processing module 22 can be configured to execute one or more commands in the program code 24C stored in the storage module 24, and perform steps S701, S703, S705, S707, S709, S711, S713, S715, S717, and S719 of method 700B in FIG. 19.

FIG. 20 is a method 700C of indexing a character according to some embodiments of the subject invention. The method 700C of indexing a character of FIG. 20 is similar to the method 700A of indexing a character of FIG. 18, and their differences will be described in detail subsequently.

The method 700C of indexing a character further includes step S702. Step S702 may follow step S701. Step S703 may follow step S702.

As shown in FIG. 20, in step S702, the processor determines an element family in the character, where the element family may include [symbol] (horizontal stroke)”, [symbol] (vertical stroke)”, [symbol] (left-falling stroke)”, “' (dot stroke)”, [symbol] (vertical-hook stroke)”, [symbol] (slant-hook stroke)”, and [symbol] (bend-hook stroke)”. This paragraph contains foreign characters to illustrate the instant invention; and these foreign characters form no part of the instant invention.

The method 700C of indexing a character of FIG. 20 determines the element family before determining the element, so that some complex Chinese fonts can be classified in the first step, to reduce the use of computing power of the electronic device and the system, and enable the electronic device and the system that perform the method of indexing a character to save memory space and make indexing of a character faster.

The subject invention provides a method of inputting a character, including: receiving, by a user interface, a first command, the first command indicating an element; displaying a first menu, the first menu including a plurality of first features that classify a first group of roots associated with the element; receiving, by the user interface, a second command to select one of the plurality of first features; displaying a second menu, the second menu including a plurality of second features that classify a second group of roots in the first group of roots, where the plurality of first features are different from the plurality of second features; receiving, by the user interface, a third command to select one of the plurality of second features; displaying a form list in response to at least the first command, the second command, and the third command; and receiving, by the user interface, a fourth command to select a form in the form list to complete an input of a character.

The subject invention provides an electronic device for inputting a character, including a display unit, a user interface, and a processor, configured to perform the following steps: receiving, by the user interface, a first command, the first command indicating an element; displaying, by the display unit and the processor, a first menu, the first menu including a plurality of first features that classify a first group of roots associated with the element; receiving, by the user interface, a second command to select one of the plurality of first features; generating, by the display unit and the processor, a second menu, the second menu including a plurality of second features that classify a second group of roots in the first group of roots, where the plurality of first features are different from the plurality of second features; receiving, by the user interface, a third command to select one of the plurality of second features; displaying, by the display unit and the processor, a form list in response to at least the first command, the second command, and the third command; and receiving, by the user interface, a fourth command to select a form in the form list to complete an input of a character.

The subject invention provides a computer program product for inputting a character, loaded by a computer to perform the following steps: receiving a first command, the first command indicating an element; displaying a first menu, the first menu including a plurality of first features that classify a first group of roots associated with the element; receiving a second command to select one of the plurality of first features; displaying a second menu, the second menu including a plurality of second features that classify a second group of roots in the first group of roots, where the plurality of first features are different from the plurality of second features; receiving a third command to select one of the plurality of second features; displaying a form list in response to at least the first command, the second command, and the third command; and receiving a fourth command to select a form in the form list to complete an input of a character.

The subject invention provides a cloud system for inputting a character, including an input module and a processing module, configured to perform the following steps: receiving, by the input module, a first command, the first command indicating an element; generating, by the processing module, a first menu, the first menu including a plurality of first features that classify a first group of roots associated with the element; receiving, by the input module, a second command to select one of the plurality of first features; generating, by the processing module, a second menu, the second menu including a plurality of second features that classify a second group of roots in the first group of roots, where the plurality of first features are different from the plurality of second features; receiving, by the input module, a third command to select one of the plurality of second features; generating, by the processing module, a form list in response to at least the first command, the second command, and the third command; and receiving, by the input module, a fourth command to select a form in the form list to complete an input of a character.

The subject invention provides a method of indexing a character, including: receiving, by a user interface, a character; determining, by a processor, a lower or right element of the character to generate a first code; determining, by the processor, one of a plurality of first features corresponding to the character; determining, by the processor, a plurality of second features that classify a second group of roots in a first group of roots, where the plurality of first features are different from the plurality of second features; determining, by the processor, one of the plurality of second features corresponding to the character; determining, by the processor, a root in the second group of roots according to the corresponding first feature and the corresponding second feature, the root having a second code; and comparing each of a form list of the root with the character to generate a third code.

The subject invention provides an electronic device for indexing a character, including a user interface and a processor, configured to perform the following steps: receiving, by the user interface, a character; determining, by the processor, a lower or right element of the character to generate a first code; determining, by the processor, one of a plurality of first features corresponding to the character; determining, by the processor, a plurality of second features that classify a second group of roots in a first group of roots, where the plurality of first features are different from the plurality of second features; determining, by the processor, one of the plurality of second features corresponding to the character; determining, by the processor, a root in the second group of roots according to the corresponding first feature and the corresponding second feature, the root having a second code; and comparing each of a form list of the root with the character to generate a third code.

The subject invention provides a computer program product for indexing a character, loaded by a computer to perform the following steps: receiving a character; determining a lower or right element of the character to generate a first code; determining one of a plurality of first features corresponding to the character; determining a plurality of second features that classify a second group of roots in a first group of roots, where the plurality of first features are different from the plurality of second features; determining one of the plurality of second features corresponding to the character; determining a root in the second group of roots according to the corresponding first feature and the corresponding second feature, the root having a second code; and comparing each of a form list of the root with the character to generate a third code.

The subject invention provides a cloud system for indexing a character, including an input module and a processing module, configured to perform the following steps: receiving, by the input module, a character; determining, by the processing module, a lower or right element of the character to generate a first code; determining, by the processing module, one of a plurality of first features corresponding to the character; determining, by the processing module, a plurality of second features that classify a second group of roots in a first group of roots, where the plurality of first features are different from the plurality of second features; determining, by the processing module, one of the plurality of second features corresponding to the character; determining, by the processing module, a root in the second group of roots according to the corresponding first feature and the corresponding second feature, the root having a second code; and comparing each of a form list of the root with the character to generate a third code.

The subject invention provides a method of inputting a character, including: inputting, by a user interface or an input/output module, a first command to select one of a plurality of elements; inputting, by the user interface or the input/output module, an N^{th} command, where N is a positive integer greater than or equal to 2, to select one of an (N−1)^{th} (N minus 1) group of root features in an (N−1)^{th} menu, which corresponds to an (N−1)^{th} group of roots, and displaying, by the user interface or the input/output module, an N^{th} menu including the (N−1)^{th} group of roots; inputting, by the user interface or the input/output module, an (N+1)^{th} (N plus 1) command to select one of the (N−1)^{th} group of roots in an N^{th} menu, and displaying, by the user interface or the input/output module, an (N+1)^{th} menu including a form list corresponding to the selected root; and/or inputting, by the user interface or the input/output module, an (N+2)^{th} command to select one of the form list of the (N+1)^{th} menu to complete an input of a character. In this embodiment of this application, the method of inputting a character may further include: inputting, by the user interface or the input/output module, a second command, to select one root feature from a first group of root features in the first menu, which corresponds to a first group of roots, where the user interface or the input/output module does not display the first group of roots; and inputting, by the user interface or the input/output module, a third command, to select one root feature from a second group of root features in the second menu, which corresponds to a second group of roots, where the user interface or the input/output module does not display the second group of roots.

Although specific embodiments of the subject invention are described above, it should be understood that the subject invention may be practiced in a way different from the described ways.

The foregoing description is intended to be illustrative and not restrictive. Accordingly, it will be apparent to those skilled in the art that modifications can be made to the subject invention described without departing from the scope of the claims as set forth below.

We claim:

1. A method of inputting a character, comprising:
receiving, by a user interface, a first command, the first command indicating an element;
displaying a first menu, the first menu comprising a plurality of first features that classify a first group of roots associated with the element;
receiving, by the user interface, a second command to select one of the plurality of first features;
displaying a second menu, the second menu comprising a plurality of second features that classify a second group of roots in the first group of roots, wherein the plurality of first features are different from the plurality of second features;
receiving, by the user interface, a third command to select one of the plurality of second features;
displaying a form list in response to at least the first command, the second command, and the third command; and
receiving, by the user interface, a fourth command to select a form in the form list to complete an input of a character.

2. The method according to claim 1, wherein the element is located at the lower right and/or bottom of the form.

3. The method according to claim 1, wherein each of the plurality of first features is associated with a main vision of a root relative to the form.

4. The method according to claim 3, wherein each of the plurality of first features refers to a position of the root relative to the form, refers to a stroke that can be added to the root relative to the form, refers to whether the root is obvious or hidden relative to the form, refers to the size of the root relative to the form, or refers to a shape of the root relative to the form.

5. The method according to claim 1, wherein each of the plurality of second features refers to a position of a root relative to the form, refers to a stroke that can be added to the root relative to the form, refers to whether the root is obvious or hidden relative to the form, refers to the size of the root relative to the form, or refers to a shape of the root relative to the form.

6. The method according to claim 5, wherein the stroke that can be added comprises an element family above or to the left of the element, wherein the element family comprises one of a horizontal stroke, a vertical stroke, a left-falling stroke, a dot, and a hook.

7. The method according to claim 1, further comprising:
displaying a third menu, the third menu comprising a third group of roots of the second group of roots corresponding to the selected second feature; and
receiving, by the user interface, a fifth command to select one root from the third group of roots.

8. The method according to claim 1, further comprising:
displaying a fourth menu before displaying the second menu, the fourth menu comprising a plurality of third features that classify a third group of roots in the first group of roots, wherein the plurality of third features are different from the plurality of first features or the plurality of second features; and
receiving, by the user interface, a sixth command to select one of the plurality of third features.

9. The method according to claim 8, further comprising:
displaying a fifth menu before displaying the fourth menu, the fifth menu comprising a plurality of fourth features that classify a fourth group of roots in the first group of roots; and
receiving, by the user interface, a seventh command to select one of the plurality of fourth features.

10. The method according to claim 9, wherein the number of the plurality of first features, the number of the plurality of second features, the number of the plurality of third features, and the number of the plurality of fourth features are all less than a first predetermined value.

11. The method according to claim 1, wherein when the form list comprises a plurality of forms, the forms are sorted according to an order of element families.

12. The method according to claim 11, wherein the form list comprises one or more of traditional Chinese characters and simplified Chinese characters.

13. The method according to claim 1, further comprising:
receiving, by the user interface, an eighth command, the eighth command indicating an element family; and
displaying an eighth menu, the eighth menu comprising an element table associated with the element family, wherein
the element table comprises the element indicated by the first command

14. The method according to claim 13, wherein the element family is one stroke and the element does not exceed four strokes.

15. The method according to claim 1, further comprising:
displaying, by a display unit, the second menu, wherein the second menu moves vertically or horizontally in the display unit during a first time.

16. A computer program product for inputting a character, loaded by a computer to perform the following steps:
receiving a first command, the first command indicating an element;
displaying a first menu, the first menu comprising a plurality of first features that classify a first group of roots associated with the element;
receiving a second command to select one of the plurality of first features;
displaying a second menu, the second menu comprising a plurality of second features that classify a second group of roots in the first group of roots, wherein the plurality of first features are different from the plurality of second features;
receiving a third command to select one of the plurality of second features;
displaying a form list in response to at least the first command, the second command, and the third command; and
receiving a fourth command to select a form in the form list to complete an input of a character.

17. A cloud system for inputting a character, comprising an input module and a processing module, configured to perform the following steps:
receiving, by the input module, a first command, the first command indicating an element;
generating, by the processing module, a first menu, the first menu comprising a plurality of first features that classify a first group of roots associated with the element;
receiving, by the input module, a second command to select one of the plurality of first features;
generating, by the processing module, a second menu, the second menu comprising a plurality of second features that classify a second group of roots in the first group of roots, wherein the plurality of first features are different from the plurality of second features;
receiving, by the input module, a third command to select one of the plurality of second features;
generating, by the processing module, a form list in response to at least the first command, the second command, and the third command; and
receiving, by the input module, a fourth command to select a form in the form list to complete an input of a character.

18. An electronic device for inputting a character, comprising a display unit, a user interface, and a processor, configured to perform the following steps:
receiving, by the user interface, a first command, the first command indicating an element;
displaying, by the display unit and the processor, a first menu, the first menu comprising a plurality of first features that classify a first group of roots associated with the element;
receiving, by the user interface, a second command to select one of the plurality of first features;
generating, by the display unit and the processor, a second menu, the second menu comprising a plurality of second features that classify a second group of roots in the first group of roots, wherein the plurality of first features are different from the plurality of second features;
receiving, by the user interface, a third command to select one of the plurality of second features;
displaying, by the display unit and the processor, a form list in response to at least the first command, the second command, and the third command; and
receiving, by the user interface, a fourth command to select a form in the form list to complete an input of a character.

19. A method of indexing a character, comprising:
receiving, by a user interface, a character;
determining, by a processor, a lower or right element of the character to generate a first code;
determining, by the processor, one of a plurality of first features corresponding to the character, wherein the plurality of first features classify a first group of roots;
determining, by the processor, a plurality of second features that classify a second group of roots in the first group of roots, wherein the plurality of first features are different from the plurality of second features;
determining, by the processor, one of the plurality of second features corresponding to the character;
determining, by the processor, a root in the second group of roots according to the corresponding first feature and the corresponding second feature, the root having a second code; and
comparing each of a form list of the root with the character to generate a third code.

20. A method of inputting a character, comprising:
(a) inputting, by a user interface or an input/output module, a first command to select one of a plurality of elements;
(b) inputting, by the user interface or the input/output module, an N^{th} command, wherein N is a positive integer greater than or equal to 2, to select one of an (N−1)^{th} group of root features in an (N−1)^{th} menu, which corresponds to an (N−1)^{th} group of roots, and displaying, by the user interface or the input/output module, an N^{th} menu comprising the (N−1)^{th} group of roots;
(c) inputting, by the user interface or the input/output module, an (N+1)^{th} command to select one of the (N−1)^{th} group of roots in an N^{th} menu, and displaying, by the user interface or the input/output module, an (N+1)^{th} menu comprising a form list corresponding to the selected root; and
(d) inputting, by the user interface or the input/output module, an (N+2)^{th} command to select one of the form list of the (N+1)^{th} menu to complete an input of a character.
